(19) United States
(12) Patent Application Publication
(10) Pub. No.: US 2009/0189471 A1
(43) Pub. Date: Jul. 30, 2009

(54) Spindle Motor

(75) Inventors: Hisato Amano, Hitachi-shi (JP); Yuji Enomoto, Hitachi-shi (JP); Matahiro Komuro, Hitachi-shi (JP); Yuichi Satsu, Hitachi-shi (JP); Fumio Tajima, Hitachi-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/181,901

(22) Filed: Jul. 29, 2008

(30) Foreign Application Priority Data
Jul. 30, 2007 (JP) 2007-196866

(51) Int. Cl. H02K 21/22

(52) U.S. Cl. 310/156.01

(57) ABSTRACT

A spindle motor having a stator and a rotor includes: a stator core provided in the stator having salient-poles; a stator coil arranged between the salient-poles; a rotor; and a permanent magnet provided in the rotor. The stator core includes a stack of steel sheets whose salient-poles are formed by etching. The permanent magnet includes a ferromagnetic material consisting mainly of iron. The ferromagnetic material has formed in laminae on a surface thereof a layer of a fluorine compound containing an alkali element, an alkaline earth element or a rare earth element formed in laminae. Near an interface between the ferromagnetic material and the layer of the fluorine compound, iron exists in the layer of the fluorine compound such that a basic crystal structure of the fluorine compound is not changed and the fluorine compound containing the iron exists in the layer of the fluorine compound.

### INCORPORATION BY REFERENCE

The disclosure of the following priority application is herein incorporated by reference:

Japanese Patent Application No. 2007-196866 filed Jul. 30, 2007.

### BACKGROUND OF THE INVENTION

1. Field of the Invention

The present invention relates to a material of a structural member of a spindle motor and a structure of motor.

2. Description of Related Art

With an increase in data size of information, it has been being demanded to develop HDDs and optical disk devices with a reduced size and a reduced weight, an increased data capacity, and an increased operation speed. In addition, from the viewpoint of convenience for mobile user it is necessary to provide a prolonged operation time of the device by a single battery charge. One of factors that determine the performance of the disk driving device is a spindle motor. In order to improve the above-mentioned performance, it is important to realize a spindle motor that can rotate with high efficiency, high speed, and high precision.

Firstly, in order to increase the data capacity, high efficiency, and high speed of the spindle motor, it is important to improve the efficiency of the spindle motor, in particular to decrease the excitation loss (or iron loss) of it.

Examples of conventional disk driving spindle motors include those disclosed in Japanese Patent Laid-Open Applications Nos. 2000-235766 and 2000-156958 and Japanese Patent No. 3551732. These patent references disclose methods for manufacturing thick magnetic steel sheets by punching. They have no description about decreasing loss of magnet.

### SUMMARY OF THE INVENTION

To enable a disk device to perform high speed transmission and reception of and large volume data, it is indispensable that the spindle motor in the disk device achieves a decrease in pulsation torque and an increase in efficiency.

The decrease in excitation loss has a greater impact on an increase in the efficiency of spindle motors to be used for high speed applications. Note that excitation loss can be expressed by a sum of hysteresis loss and eddy current loss of an electromagnetic steel sheet, and eddy current loss.

The hysteresis loss is a loss that occurs when the orientation of magnetic domains of the magnetic core is changed due to alternating magnetic field and depends on an area inside a hysteresis curve on the magnetic core.

The stator core that constitutes the stator or the spindle motor is fabricated by stacking magnetic steel sheets to form a magnetic circuit in order to decrease the eddy current loss.

The stator core includes salient-poles and thus has a complicated form. Currently, stator cores are produced by punching. When punching is performed, the magnetic steel sheets undergo deformations in crystal structures of cut portions thereof. This deteriorates magnetic characteristics, increases the area inside the hysteresis curve, and increases the excitation loss, so that the efficiency of the spindle motor is not improved.

Since the spindle motor has an outer diameter of 10 mm to 30 mm and precision is needed to perform a punching operation. On the other hand, the punching operation provides only poor precision and is disadvantageous in that cogging torque and torque ripple are not improved.

While it is necessary to use a rare earth magnet for achieving high efficiency, a conductive rare earth magnet is susceptible to eddy current loss, so that the efficiency of motor is not improved.

When the rotation number of the motor is increased in order to achieve high efficiency, it is necessary to decrease the eddy current loss that occurs in the magnet since the eddy current loss increases in proportion to a square of the rotation number.

To decrease the eddy current loss of the magnet, a technique is known that includes interrupting the path of eddy current by dividing the magnet. However, division of the magnet gives rise to magnets having complicated shapes and results in an increase of the number of parts, so that the cost of manufacturing the motor increases. Use of a ferrite magnet and a rare earth bond magnet, which have low conductivities, enables to suppress eddy current loss that would otherwise occur in the magnet. However, the magnet has a low energy product so that no sufficient efficiency of the motor can be obtained.

It is an object of the present invention is to obviate the above-mentioned defects of the conventional spindle motor and provide a spindle motor that has a decreased excitation loss and a high efficiency and a disk drive device equipped with such a spindle motor that is capable of high speed, large volume recording and can be used for a long period of time.

According to a principal embodiment of the present invention, there is provided a spindle motor having a magnet in which the magnet is partially insulated with a layer containing a fluorine compound containing at least one of a rare earth element and an alkaline earth element and which has a high resistance and a high energy product. Further, the steel sheet is worked by etching with high precision in order to increase prevent the deterioration of the magnetic characteristics of the magnetic steel sheet due to punching and further increase the magnetic characteristics of the steel sheet.

According to the present invention, there is obtained a spindle motor that has a decreased excitation loss and a high efficiency and a disk drive device equipped with such a spindle motor that is capable of high speed, large volume recording and can be used for a long period of time.

### BRIEF DESCRIPTION OF THE DRAWINGS

FIG. 1 is a schematic cross-sectional view showing a spindle motor according to an embodiment of the present invention;

FIG. 2 is a schematic cross-sectional view showing a HDD device according to an embodiment of the present invention;

FIG. 3 is a graph illustrating the relationship between magnetization magnetic field and intensity of magnetization of a high resistance magnet;

FIG. 4 is a graph illustrating the relationship between the number of magnet poles and motor characteristics;

FIG. 5 is a graph illustrating the relationship between the motor gap and the motor efficiency;

FIG. 6 is a graph illustrating the relationship between the recoil permeability and the motor efficiency;

FIGS. 7A to 7H are each an EDX analysis profile;

FIG. 8 is a transmission electron micrograph;

FIG. 9 is a transmission electron micrograph;

FIG. 10 is a transmission electron micrograph and an electron beam diffraction image;

FIGS. 11A to 11C are cross-sections illustrating how to assemble a spindle motor;

FIGS. 12A to 12E present cross-sectional views illustrating a process for fabricating a magnetic film;

FIG. 13 is a graph illustrating the relationship between the thickness of a magnetic steel sheet and the excitation loss;

FIG. 14 is a graph illustrating the relationship between the content of silicon in a silicon steel sheet and the excitation loss;

FIG. 15A to 15D are each a schematic diagram showing typical worked surfaces by etching; and

FIG. 16 is a schematic diagram showing typical worked surfaces by punching.

### DETAILED DESCRIPTION OF THE INVENTION

Hereinafter, an embodiment of the present invention is described referring to the attached drawings.

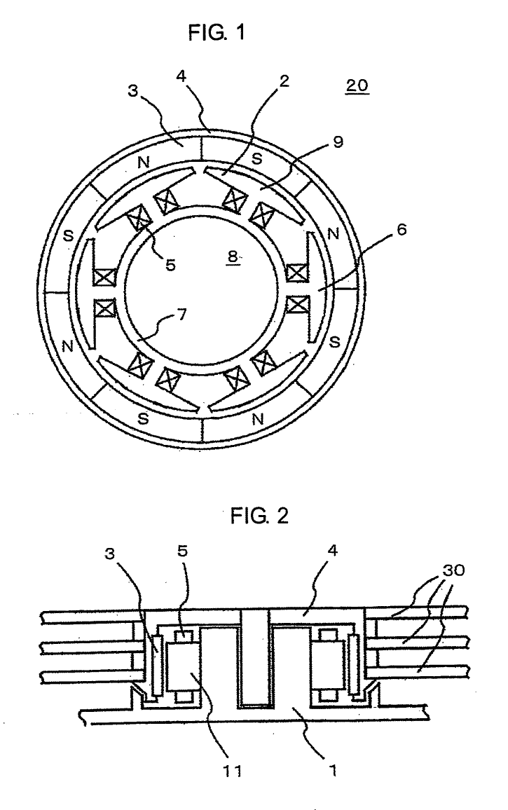

FIG. 1 shows a spindle motor according to an embodiment of the present invention. A permanent magnet motor of the present embodiment is of an outward rotation type and a 4:3 structure spindle motor having an eight-pole rotor 20 and a six-pole stator 8. The rotor 20 has the eight-pole permanent magnet 3 and a hub 4 that fixes the permanent magnet 3 thereto. The stator 8 has six salient-poles 6. Each salient-pole has wound thereon s stator coil. Since how to detect a pole position of the permanent magnet 3 is not essential and description has been omitted herein. Brushless type motors are known. In one example, a Hall element is provided on a housing 1 and in another type, induced voltage that is generated in the stator coil is detected.

As the permanent magnet 3, there is used a high resistance magnet that is a partially insulated with a layer containing a fluorine compound that contains at least one element selected from a rare earth element and an alkaline earth element and has characteristics of a remanence of 1.0 T or more and 1.4 T or less and a specific resistance of 0.2 to 2 mΩcm. By using such a high performance, high resistance magnet, only eddy current can be decreased without damaging the characteristics of the magnet.

By manufacturing the stator 8 by etching thin sheets instead of the punching used in the conventional technique, deterioration of the magnetic characteristics at the cut portions can be prevented and precision of working can be further increased, so that cogging torque and torque cripple are decreased, thereby improving the efficiency of the motor.

As mentioned above, when the loss on the side of the rotor is decreased, the ratio of loss on the side of the stator is increased. However, manufacture of the stator 8 by etching of thin sheets enables the loss on the side of the stator to be decreased, so that the efficiency of the motor is significantly improved.

FIG. 2 shows an example of the HDD apparatus with the spindle motor according to an embodiment of the present invention.

The spindle motor used in the HDD device of the present embodiment is the spindle motor of the outward rotation type described with reference to FIG. 1. Use of the high efficiency magnet and the etched magnetic steel sheets enables high efficiency to be realized.

The HDD device having such a construction can provide very high efficiency, so that the HDD device can be made smaller and lighter in weight. It can have higher capacity and higher operation speed. In addition, its service time per single battery charge can be increased. Since the cogging torque of the spindle motor is small as a result of improvement of the precision of working of the magnetic steel sheets, fluctuation in rotation speed of a disk 30 in which magnetic information is recorded can be reduced. Accordingly, recording and reproduction of the magnetic information can be performed more stably and at higher speed with increased reliability, and the recording density can be increased.

While explanation is made on the HOD device as an example in the present embodiment, the present invention is not limited to the HDD device. When the spindle motor of the present invention is used in a CD-ROM device and a DVD device that record/reproduce information in/from the disk 30 with laser beam a very high efficiency can be obtained. As a result the HDD device can be made smaller and lighter in weight and have higher capacity and higher operation speed. In addition, its service time per single battery charge can be increased and fluctuation in rotation speed of the disk 30 can be minimized. Therefore, recording and reproduction of information with laser beam is stabilized and reliability and recording density can be increased.

As another embodiment, a spindle motor of a multipole structure having eight or more poles in the permanent magnet 3 in the rotor 20 and six or more salient-poles 6 in the stator 8 shown in FIG. 1 is described. By adopting the multipole structure having eight or more poles in the permanent magnet 3 in the rotor 20 and six or more salient-poles 6 in the stator 8, the magnetic flux density in a motor gap between the stator 8 and the rotor 8 is increased to 0.1 T or more, which increases the motor output power and hence the response and efficiency of the spindle motor. However, the frequency of the motor at the same rotation number increases in proportion to the number of poles of the permanent magnet 3 in the rotor 20 and an increase in eddy current loss occurring in the magnet cannot be ignored to prevent improvement of efficiency. Accordingly, in the present embodiment, a high resistance magnet is used in all or a portion of the permanent magnet 3 in the rotor 20 in order to suppress the eddy current loss occurring in the magnet, so that improvement of the efficiency of the motor can be achieved by adopting the multipole structure.

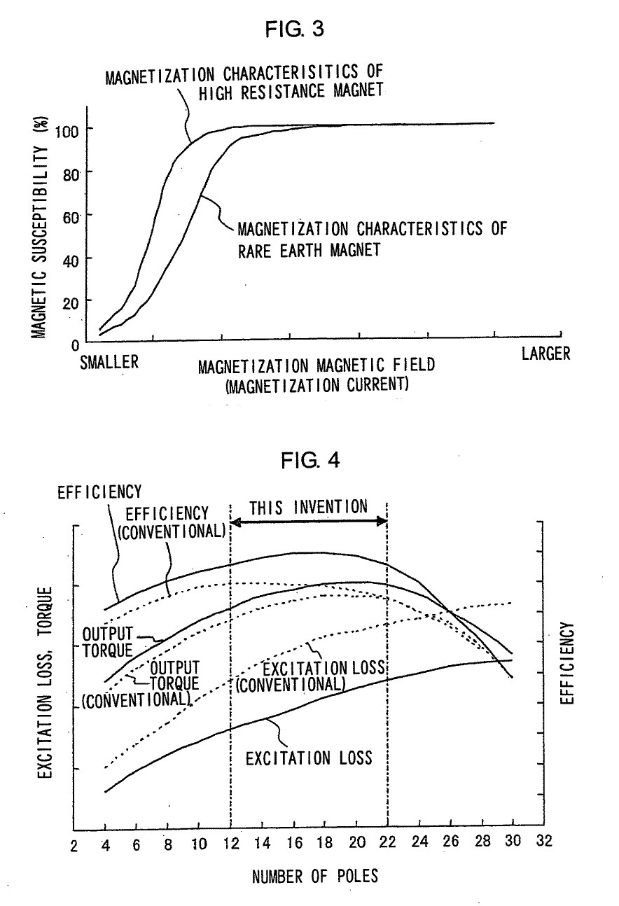

As mentioned above, by adopting the multipole structure, the width per pole of the permanent 3 in the rotor 20 decreases, the ratio of a non-magnetized portion between poles, i.e., so-called neutral zone, increases, and in addition, the area of the neutral zone increases in proportion to the number of poles, so that the total magnetic flux of the magnet decreases. To increase the efficiency of the motor, it is necessary to reduce the neutral zone. Generally, rare earth magnets are magnetized by pulse magnetization. In this case, diamagnetic fields generated by eddy current occurring in the inside of the magnet upon magnetization make it difficult for the magnetization to be achieved, so that a very high magnetization field is required. To increase the magnetization field, it is necessary to increase the ampere turn, i.e., winding number, of the magnetization coil. However, when the winding number increases, a broader winding space is needed. This necessitates a wider distance between the poles of the magnetization coils in proportion to the breadth of the winding space, resulting in that the neutral zone becomes broader. However, the high resistance magnet used in the present invention generates almost no eddy current so that it is possible to magnetize it at a lower magnetic field than the magnetic field at which a conventional magnet is magnetized. As a result, the winding number of the magnetization coil can be decreased and the width of the neutral zone can be decreased to 0.5 mm or less. FIG. 3 shows a comparison on magnetization characteristics between the conventional rare earth magnet and the high resistance magnet. On the other hand, when pulse magnetization is not used, the time of applying current to the magnetization coil is longer and the magnetization coil generates heat. Accordingly, it is difficult to decrease the width of the neutral zone and at the same time provide a sufficient magnetization field. As mentioned above, in the present invention, use of the high resistance magnet enables realization of a multipole magnet of which the size of the neutral zone is minimized to improve the efficiency of the motor. In addition, by adopting a multipole structure and a narrower neutral zone, the working point of the magnet is improved. This decreases the quantity of the magnet for obtaining the same torque to reduce cost.

Adopting the multipole structure increases the motor frequency and increasing the magnetic flux density of the stator 8 increases the excitation loss an the side of the stator. However, use of low loss magnetic steel sheets prepared by etching can suppress an increase in loss on the side of the stator. Accordingly, using the low loss magnetic steel sheets and the high efficiency magnet in combination, the motor efficiency can be improved. In addition, use of multipole construction results in an increase in basic frequency of the motor, so that it is possible to decrease sound and vibration of the motor.

FIG. 4 presents a relationship diagram illustrating the relationship between the number of poles of the magnet and the characteristics of the motor. With an increasing number of poles of the magnet, the output torque of the motor increases. However, by contraries, when the number of poles is too large, the output torque decreases due to influences of the above-mentioned neutral zone, magnetic saturation, and excitation loss and so on. In addition, when the number of poles of the magnet increases, the magnetic flux density in the core increases, so that the excitation loss increases. In the present invention, use of the high resistance magnet and low loss magnetic steel sheets prepared by etching provides the highest efficiency particularly when the number of poles of the magnet is between 12 and 22. Therefore, it is possible to increase the efficiency of the motor by adopting the multipole structure.

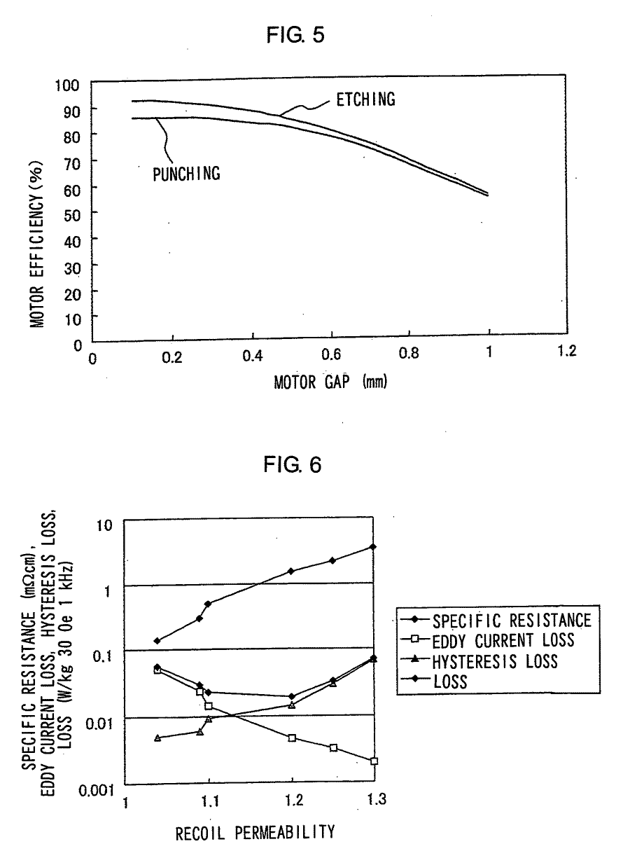

In a still another embodiment, the motor gap between the stator 8 and the rotor 20 is decreased to increase the magnetic flux density of the motor gap to 0.1 T or more. Therefore, the output of the motor increases and hence it is possible to increase the efficiency of the motor. However, when the stator 8 is manufactured by punching as shown in the conventional technique, the magnetic characteristics of the cut portions of the stator 8 are deteriorated to increase the excitation loss. Further, such a conventional stator has a poor working precision so that it has its limitations in minimizing the motor gap. In contrast, in the present invention, since the etched cut surface of the core is free of magnetic deterioration, decreasing the motor gap enables the efficiency of the motor to be increased more effectively than punched cut surface of the core. Since etching can provide working with high precision, manufacture of a stator with a minimized motor gap is possible. FIG. 5 is a graph that compares the motor efficiency depending on a motor gap between the punched core and the etched core.

Now, the high resistance magnet of the present invention is described.

### Example 1

Rapidly quenched powder consisting mainly of Nd₂Fe₁₄B is prepared as NdFeB series powder. On surfaces of grains of the powder is formed a fluorine compound. When NdF₃ is to be formed on the surface of the grains of the rapidly quenched powder, Nd(CH₃COO)₃ used as a material is dissolved in H₂O and HF is added to the obtained solution. Addition of HF gives rise to gel-like or gelatinous NdF₃.XH₂O, which is centrifuged to remove the solvent. The resultant is mixed with the above-mentioned NdFeB powder. The solvent in the mixture is evaporated and the hydrated water is evaporated by heating. The formed film was examined by XRD (X-Ray Diffraction). The results of the XRD indicate that the film of the fluorine compound is constituted by NdF₃, NdF₂, and NdOF and so on. The powder, which has a grain size of 1 μm to 300 μm, is heated at a temperature lower than a heat treatment temperature of 800° C. at which magnetic characteristics of the powder are decreased while preventing oxidation. As a result, there is obtained magnetic powder having formed on the surface thereof a high resistance layer and having a remanence of 0.7 T or more. When the grain size is less than 1 μm, the powder is susceptible to oxidization and their magnetic characteristics tend to be deteriorated. When the grain size is larger than 300 μm, magnetic characteristics improving effect of the fluorine compound formation including the effect of increasing resistance or other effects are weakened. To obtain magnetic characteristics, the magnetic powder is charged into a mold and preformed at a compressive load of 2 t/cm², and then pressure formed at a temperature of 500° C. or higher and 800° C. or lower in a larger mold without exposing the powder to atmosphere. On this occasion, under a compressive load of 1 t/cm² or more, the magnetic powder consisting mainly of the fluorine compound and Nd₂Fe₁₄B, a matrix (or host phase), in the mold is deformed to exhibit magnetic anisotropy. As a result, the obtained molding had a remanence of 1.0 T or more and 1.4 T or less and a high resistance magnet having a specific resistance of 0.2 mΩcm to 2 mΩcm is obtained. The squareness of a demagnetization curve of a molding depends on molding conditions and conditions of formation of the fluorine compound. This is because the c-axis, which is a crystal axis of the matrix Nd₂Fe₁₄B has a different orientation depending on the molding conditions and the conditions of the formation of the fluorine compound. In addition, structural analysis by use of a transmission electron microscope and compositional analysis revealed that the inclination of the demagnetization curve of the molding in the vicinity of zero magnetic field depends on degree of dispersion of the orientation of the c-axis and the structure and composition in the vicinity of the boundary between the magnetic powder and the fluorine compound. In the case of the molding having a density of 90 to 99%, the layer of the fluorine compound coalesces with, disperses in, and causes grain growth in the molding and the fluorine compound layer on the surface of the magnetic powder serves as a binder in the molding and is partially sintered. When the thickness of the fluorine compound film was about 500 nm, the grain size of the fluorine compound immediately after the formation of the fluorine compound on the magnetic powder is 1 nm to 100 nm. In contrast, the grain size of the fluorine compound in the molding is 10 nm to 500 nm. There are found many portions where the fluorine compound layers formed on surfaces of different magnetic powder grains bind to each other and crystal grains grow and are sintered therein. It is found that there is iron in the crystals of the fluorine compound that has undergone grain growth. Since the iron does not exist in the fluorine compound before the grain growth, it is considered that the iron has migrated by diffusion from the magnetic powder upon grain growth. It can be presumed that along with the diffusion of iron, rare earth elements and oxygen that is present on the surface of the magnetic powder from the beginning could also diffuse. The fluorine compound in which iron is diffused is in the form of more often NdF₂ than NdF₃. The concentration of iron in the fluorine compound measured by EDX analysis is in average 1% or more and 50% or less. The composition containing iron in the vicinity of 50% based on the total mass of the composition is amorphous. Since oxygen is also contained, the molding contained NdF₂, NdF₃, Nd(O, F), and NdFeFO amorphous materials as well as NdFeB magnetic powder having a matrix of Nd₂Fe₁₄B. It is found that the fluoride compound and the oxide fluoride compound contain in average 1% to 50% of iron. Although it is unclear which sites iron atoms are arranged on in the fluoride compound and the oxide fluoride compound, it is assumed that iron is substituted at sites of fluorine or rare earth elements. Both the above-mentioned high remanence and high specific resistance can be achieved by forming a fluorine compound layer on R—Fe—X is (where R represents a rare earth element, and X represents a third element) or R-T compound (where R represents a rare earth element, T represents Fe, Co, or Ni), allowing grains to grow in the fluorine compound to diffuse and react with the matrix, and sintering the fluorine compound layer to form a binder. Examples of such a fluorine compound include RFₙ (where n is 1 to 3) constituted by an element R selected from elements consisting of at least one of Li, Mg, Ca, 3d transient elements and rare earth elements and fluorine and contains 1% to 50% of iron from the magnetic powder by thermal forming. If the concentration of iron in the fluorine compound is higher than 50%, e.g., 50% to 80%, a portion of the fluorine compound layer becomes amorphous and there is a possibility that the magnetic characteristics are deteriorated. Accordingly, it is necessary to select conditions of thermal forming and conditions of formation of the fluorine compound such that the concentration of iron in the fluorine compound is 50% or less.

The fluorine compound layer can be formed by a surface treatment of the magnetic powder with a solution at least one fluorine compound selected from LiF, MgF₂, CaF₂, ScF₃, VF₂, VF₃, CrF₂, CrF₃, MnF₂, MnF₃, FeF₂, FeF₃, CoF₂, CoF₃, NiF₂, ZnF₂, AlF₃, GaF₃, SrF₂, YF₃, ZrF₃, NbF₃, AgF, In F₃, SnF₂, SnF₄, BaF₂, LaF₂, LaF₃, CeF₂, CeF₃, PrF₂, PrF₃, NdF₂, SmF₂, SmF₃, EuF₂, EuF₃, GdP₃, TbF₃, TbF₄, DyF₂, DyF₃, HoF₂, HoF₃, ErF₂, ErF₃, TmF₂, TmF₃, YbF₂, YbF₃, LuF₂, LuF₃, PbF₂, and BiF₃, or with a solution containing at least one of these fluorine compounds and at least one of oxygen and carbon. By controlling the concentration of iron in the fluoride compound or oxide fluoride compound in the range of 1% or more and 50% or less, the magnet can have a recoil magnetic permeability of 1.05 to less than 1.30 to decrease the magnetic loss of the magnet.

### Example 2

Formation of a layer of DyF₃ or TbF₃ on high remanence Nd₂Fe₁₄B magnetic powder that contains no high coercivity elements such as Dy, Tb, and Pr enables to obtain high remanence and high coercivity. An alloy having a composition close to that of Nd₂Fe₁₄B was dissolved by high-frequency melting to prepare a cast ingot. The ingot is pulverized to powder having a grain size of 1 μm to 10 μm by using a pulverizer. To form a layer of a fluorine compound (hereafter, fluorine compound layer) on a surface of grains of the powder, a treatment liquid prepared by centrifuging gel-like or gelatinous DyF₃.XH₂O or TbF₃.XH₂O to remove the solvent is mixed with the above-mentioned NdFeB powder. The solvent of the obtained mixture is evaporated and hydrated water in the mixture is evaporated. The thus treated powder is placed in a magnetic field of 0.5 T to 1 T to orient the magnetic powder. The oriented magnetic powder was sintered in vacuum at a temperature of 900° C. to 1,100° C. for 4 hours and then heat treated at 600° C. to obtain a sintered compact having a density of 90% to 99%. When Dy fluoride compound is prepared, the fluorine compound layer includes DyF₂, DyF₃, and Dy(O, F). It is observed that Fe or Nd diffuses into the fluoride compounds or the oxide fluoride compound. If the content of Fe increases in the fluorine compound layer, it becomes impossible to increase coercivity, the content of Fe in the fluorine compound layer must be controlled to 50% or less based on the total mass of the fluorine compound layer. The above-mentioned Dy and Tb also segregate in the vicinity of the grain boundary after the sintering, so that both high remanence and high coercivity are attained. As mentioned above, by forming the fluorine compound layer by surface treatment on the surface of the magnetic powder to form thereon a rare earth element-rich phase that contributes to enhancement of coercivity in an artificial manner, a sintered magnet having a remanence of 1.3 T to 1.6 T, a coercivity of 20 kOe to 35 kOe, and acceptable squareness can be obtained. The rapidly quenched magnetic powder surface-treated with the fluorine compound is heat treated at 500° C. to 800° C. before it is charged in a press machine. This heat treatment provides the following improvements in the characteristics. With the heat treatment, a portion that contains 1 atomic % of iron is formed in the fluorine compound layer and diffusion of iron among the atoms of the rare earth element. With the heat treatment at temperatures higher than 800° c., a soft magnetic phase such as α(alpha)-Fe grows, which deteriorates the magnetic characteristics of the magnet. The improvements obtained by the heat treatment at 500° C. to 800° C. include improvement in coercivity, improvement in squareness, improvement in temperature characteristics, and an increase in resistance and soon. As a result, a bond magnet can be prepared by molding a mixture of the treated magnetic powder and an organic binder.

### Example 3

Rapidly quenched powder consisting mainly of Nd₂(Fe,CO)₁₄B is prepared as the NdFeB series powder. On the surface of grains of the powder is formed a fluorine compound. The rapidly quenched powder may contain amorphous material. When DyF₃ is to be formed on the surface of the grains of the rapidly quenched powder, Dy(CH₃COO)₃ used as a material is dissolved in H₂O and HF is added to the obtained solution. Addition of HF gives rise to gel-like or gelatinous NdF₃—XH₂O, which then is centrifuged to remove the solvent. The resultant is mixed with the above-mentioned NdFeB powder. The solvent in the mixture is evaporated and the hydrated water is evaporated by heating. The formed fluorine compound layer having a film thickness of 1 nm to 1,000 nm is examined by XRD. The results of the XRD indicate that the film of the fluorine compound is constituted by DyF₃, DyF₂, and DyOF and so on. The powders which has a grain size of 1 μm to 300 μm, is heated at a temperature lower than a heat treatment temperature of 800° C. at which magnetic characteristics of the powder are decreased while preventing oxidation. As a result, there is obtained magnetic powder having formed on the surface thereof a high resistance layer and having a remanence of 0.7 T or more. In this case, it is confirmed that the heat treatment at 350° C. to 750° C. results in an improvement in coercivity and squareness of the magnetic powder. If the grain size is less than 1 μm, the powder was susceptible to oxidization and their magnetic characteristics were vulnerable to deterioration. On the other hand, if the grain size is more than 300 μm, the effect of increasing resistance or another effect of improving the magnetic characteristics by formation of the fluorine compound is poor. To obtain magnetic characteristics, the magnetic powder was charged into a mold and preformed at a compressive load of 1 t/cm², and then pressure formed at a temperature of 400° C. or higher and 800° C. or lower in a larger mold without exposing the powder to atmosphere. On this occasion, under a compressive load of 1 t/cm² or more, the magnetic powder consisting mainly of the fluorine compound and Nd₂Fe₁₄B, the matrix, in the mold is deformed to exhibit magnetic anisotropy. As a result, the obtained molding had a remanence of 1.0 T or more and 1.4 T or less and a high resistance magnet having a specific resistance of 0.2 mΩcm to 20 mΩcm was obtained. The squareness of a demagnetization curve of the molding depends on molding conditions and conditions of formation of the fluorine compound. This is because the c-axis, which is a crystal axis of the matrix Nd₂Fe₁₄B, has a different orientation depending on the molding conditions and the conditions of the formation of the fluorine compound. In addition, results of structural analysis by use of a transmission electron microscope and compositional analysis indicate that the inclination of the demagnetization curve of the molding in the vicinity of a zero magnetic field depends on the degree of dispersion of the orientation of the c-axis and the structure and composition in the vicinity of the boundary between the magnetic powder and the fluorine compound. In the case of the molding having a density of 90 to 99%, the layers of the fluorine compound coalesce with, disperse in, and cause grain growths in the molding and the fluorine compound layer on the surface of the magnetic powder serves as a binder in the molding and partially sintered. When the thickness of the fluorine compound film is about 500 nm, the grain size of the fluorine compound immediately after the formation of the fluorine compound on the magnetic powder is 1 nm to 100 nm. In contrast, the grain size of the fluorine compound in the molding is 10 nm to 500 nm. There are found many portions where the fluorine compound layers formed on surfaces of different magnetic powder grains bind to each other and grains grow to be sintered therein. It is found that there are iron, cobalt, and Nd in the crystals of the fluorine compound that has undergone grain growth. Since the iron does not exist in the fluorine compound before the grain growth, it is considered that the iron migrated by diffusion from the magnetic powder upon grain growth. It can be presumed that along with the diffusion of iron, rare earth elements and oxygen that is present on the surface of the magnetic powder from the beginning could also be diffused. The fluorine compound in which iron has been diffused is in the form of more often DyF₂ than DyF₃. The concentration of iron in the fluorine compound measured by EDX analysis is in average 1% or more and 50% or less. The composition containing iron in the vicinity of 50% is amorphous. Since the composition also contains oxygen, the molding contains (Dy,Nd)F₂, NdF₃, Nd(O,F), and DyFeFO amorphous materials in addition to the NdFeB magnetic powder having a matrix of Nd₂Fe₁₄B. It is found that the fluoride compound and the oxide fluoride compound contain in average 1% to 50% of iron. Although it is unclear which sites iron atoms are arranged on in the fluoride compound and the oxide fluoride compound, it is assumed that iron is substituted at sites of fluorine or rare earth elements. Both the above-mentioned high remanence and high specific resistance can be achieved by forming a fluorine compound layer on R—Fe—X (where R represents a rare earth element, and X represents a third element) or R-T compound (where R represents a rare earth element, T represents Fe, Co, or Ni), allowing grains in the fluorine compound to grow and react with the matrix by diffusion, and allowing the fluorine compound layer to serve as a binder for sintering. The fluorine compound can be used as a binder for Fe series soft magnetic materials such as amorphous magnetic materials, silicon steel plates and magnetic steel sheets as well as NdFeB series magnets and SmCo series magnets. When it is irradiated with millimeter waves or micro waves, the fluorine compound preferentially generates heat to bind the materials.

### Example 4

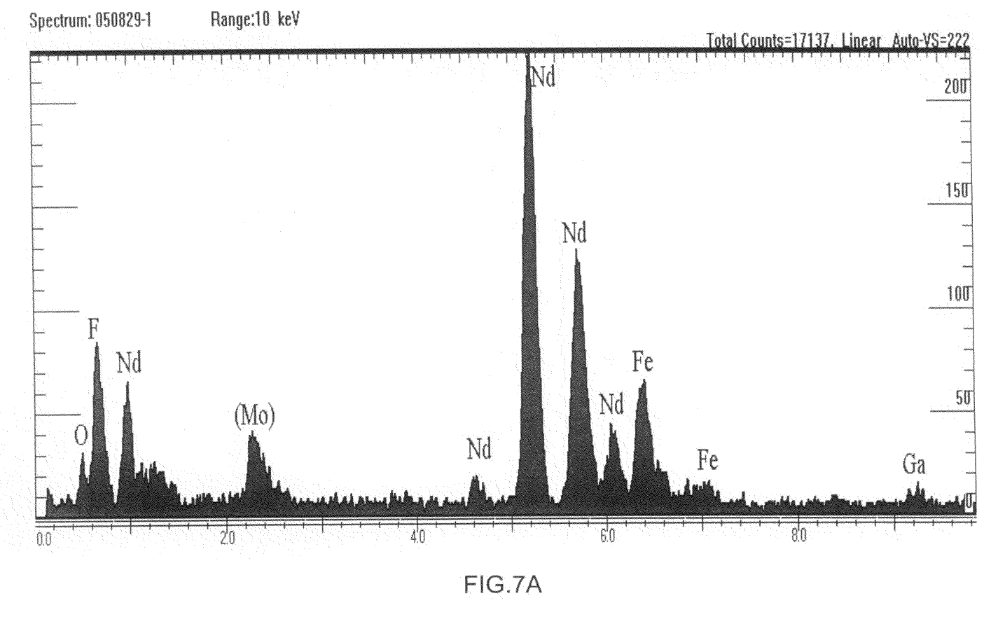

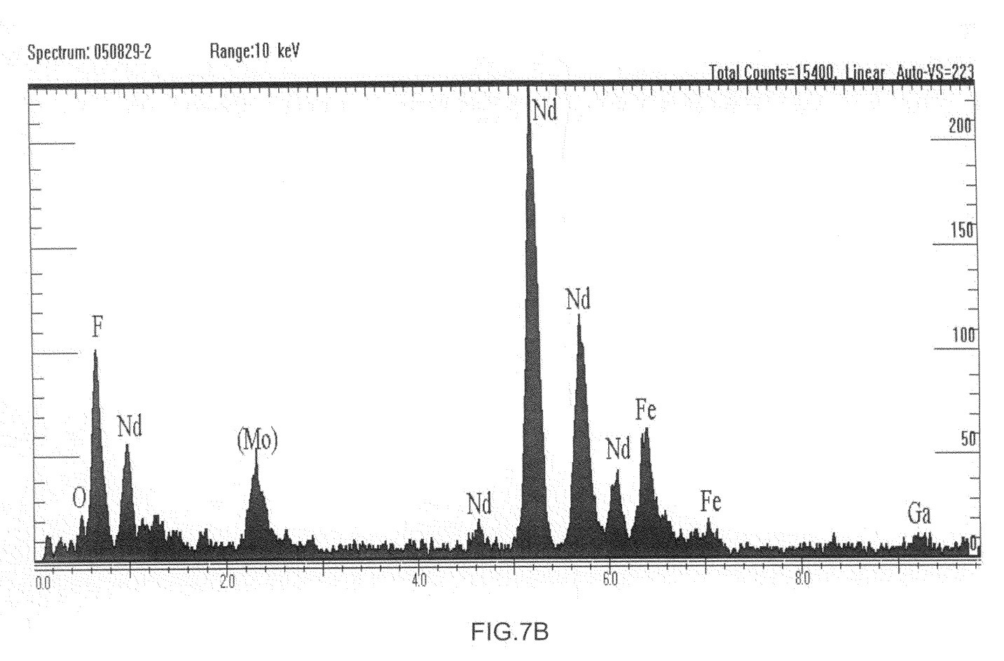

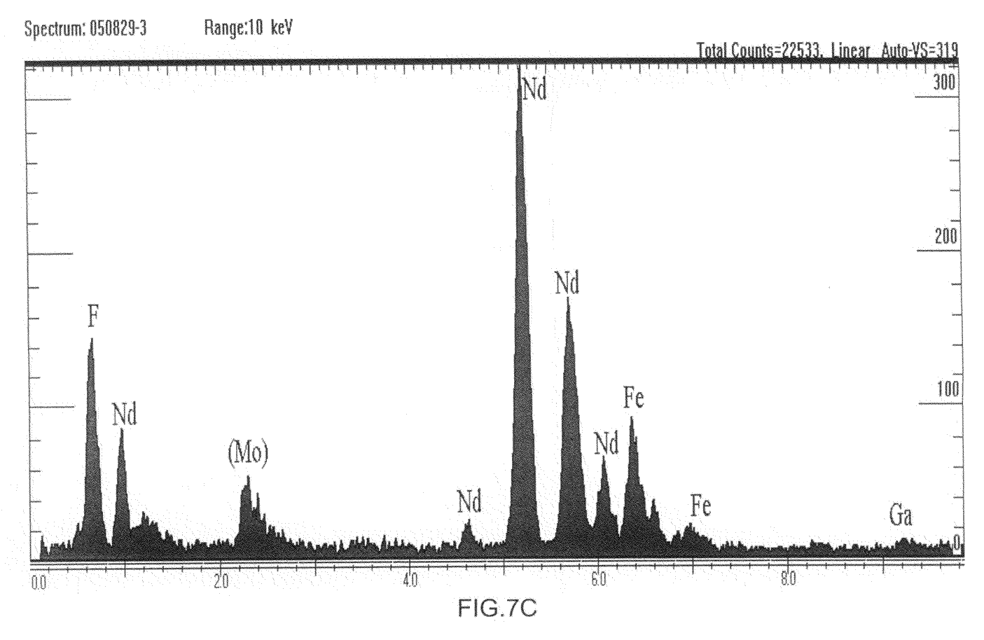

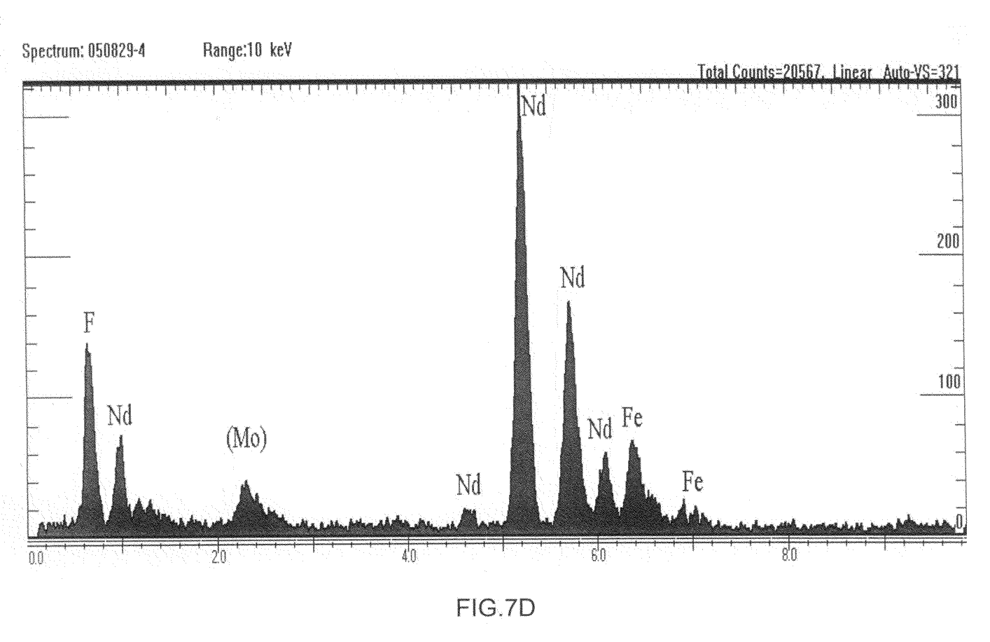

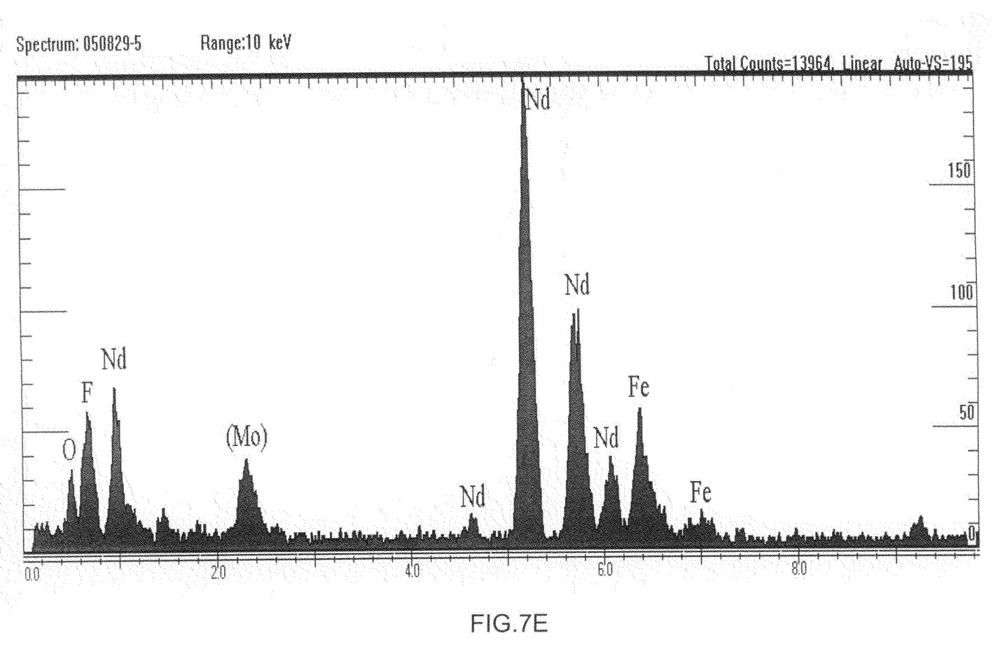

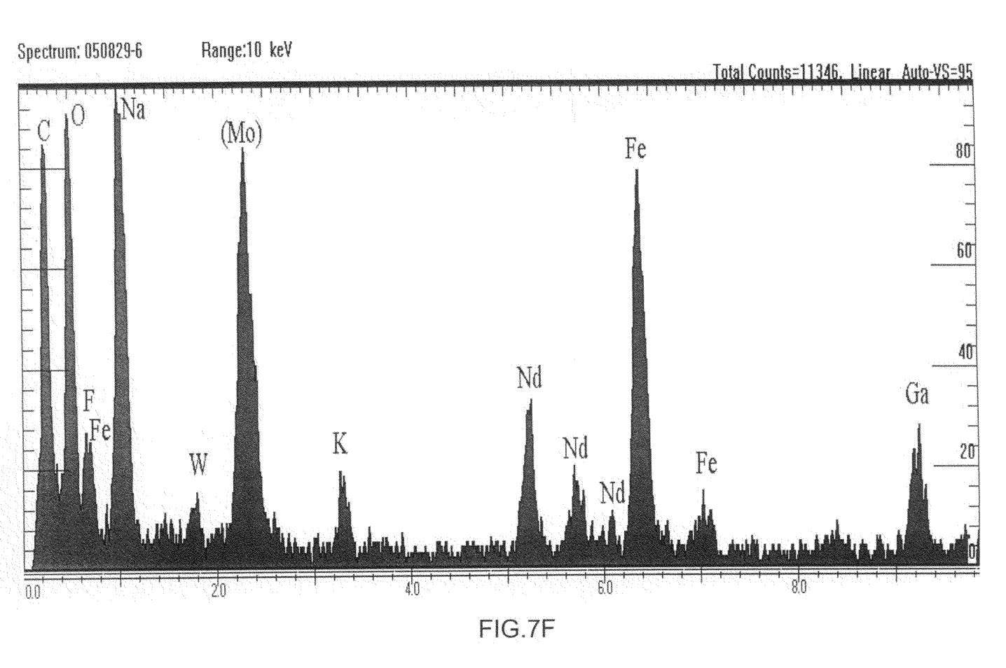

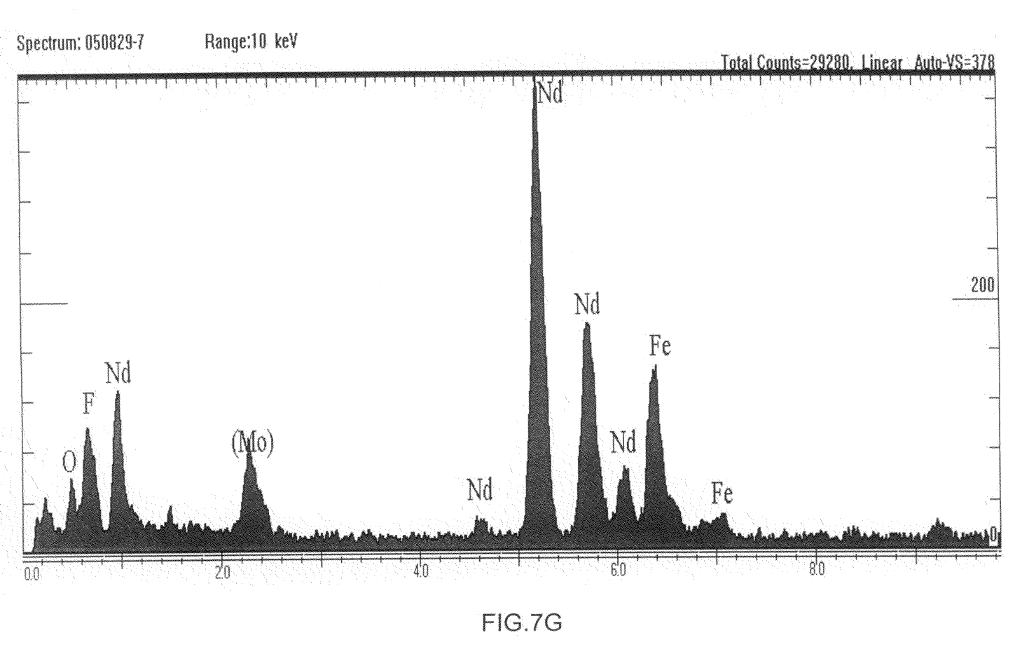

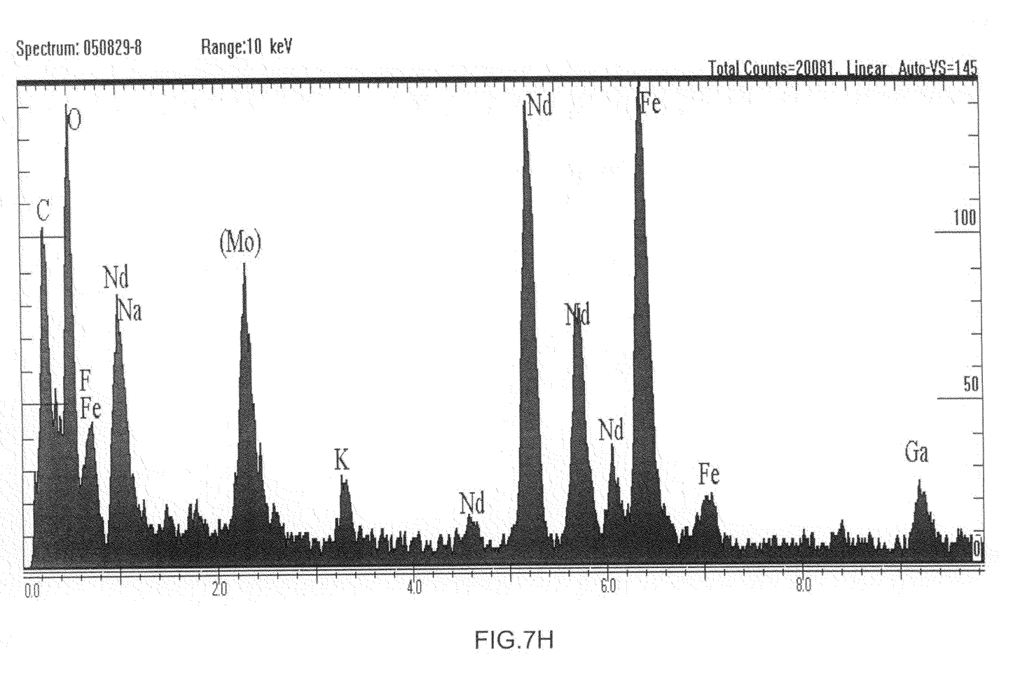

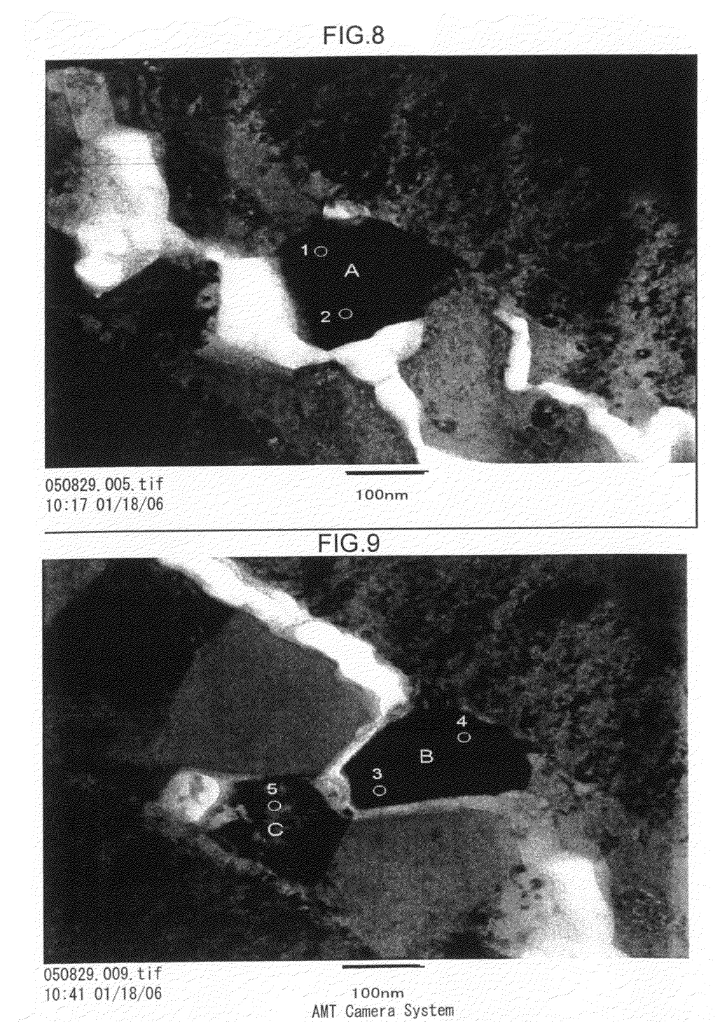

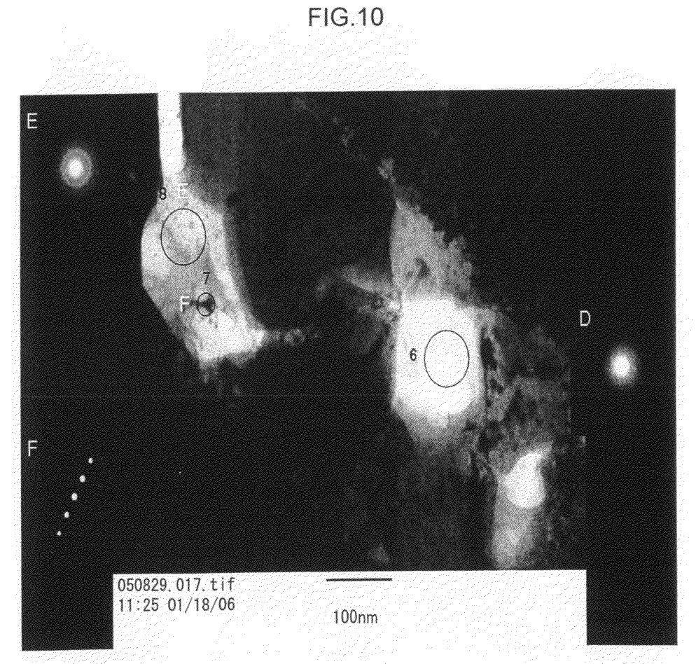

Rapidly quenched powder consisting mainly of Nd₂(Fe,Co)₁₄B is prepared as the NdFeB series powder. On the surface of grains of the powder is formed a fluorine compound. The rapidly quenched powder, which includes flat grains having a thickness of 15 μm to 50 μm, may contain an amorphous material. When NDF₃ is to be formed on the surface of the grains of the rapidly quenched powder, Nd(CH₃COO)₃ used as a material is dissolved in H₂O and HF is added to the obtained solution. Addition of HF gives rise to gel-like or gelatinous NdF₃.XH₂O, which then is centrifuged to remove the solvent. The resultant is mixed with the above-mentioned NdFeB powder. The solvent in the mixture is evaporated and the hydrated water is evaporated by heating. The formed fluorine compound layer having a film thickness of 1 nm to 1,000 nm is examined by XRD. The results of the XRD indicate that the film of the fluorine compound is constituted by NdF₃, NdF₂, and NdOF and so on. The powder, which has a grain size of 1 μm to 300 μm, is heated at a temperature lower than a heat treatment temperature of 800° C. at which magnetic characteristics of the powder are decreased while preventing oxidation. As a result, there is obtained magnetic powder having formed on the surface thereof a high resistance layer and having a remanence of 0.7 T or more. In this case, it is confirmed that the heat treatment at 350° C. to 750° C. results in an improvement in coercivity and squareness of the magnetic powder. If the grain size of the magnetic power is less than 1 μm, the magnetic powder is susceptible to oxidization and their magnetic characteristics are vulnerable to deterioration. On the other hand, if the grain size of the magnetic powder is more than 300 μm, the effect of increasing resistance or another effect of improving the magnetic characteristics by formation of the fluorine compound is poor. When molding is performed, the magnetic powder is charged into a mold and then preformed therein at a temperature of 400° C. or higher and 800° c. or lower under a compressive load of 1 t/cm². As a result, the obtained molding has a remanence of 0.7 T to 0.9 T and a high resistance magnet having a specific resistance of 0.2 mΩcm to 20 mΩcm is obtained. The molding has different densities when molded at different thermal forming temperatures. To obtain a density of 90% or more, it is desirable to perform molding at 500° C. to 800° C. Molding at higher temperatures provides higher densities. However, other elements tend to more easily diffuse into the fluorine compound layer, so that it is desirable to perform molding at lower temperatures to obtain high densities. FIGS. 8 to 10 are transmission electron micrographs of cross-sections of samples. In the texture of the NdF₃-coated magnetic powder before thermal forming, the NdF₃ grains in the NdF₃ layer had a grain size of 1 nm to 20 nm. By thermal forming, the NdF₃ grains grew and had a grain size of 100 nm or more as shown in a portion indicated by letter “A” in FIG. 8. The EDX analysis profiles of the portion A are shown in FIGS. 7A and 7B, which correspond to the compositions of the grain in encircled areas numbered 1 and 2, respectively, of the portion A. As shown in FIGS. 7A and 7B, the profiles indicate that there are found Nd, Fe, F, O, Mo, and Ga. Mo is derived from a mesh material on which a TEM sample is mounted but is not a signal from the molding. Ga is derived from ion irradiated for thinning the sample for TEM observation. No Fe was observed in the profile of the NdF₃ or NdF₂ layer immediately after the coating. From this it can be presumed that upon thermal forming, Fe diffused into the fluorine compound. When portions other than the portion A were observed, Fe was found in an abundance of 1 atomic % as a ratio of Fe to the sum of the elements excluding B. When molding was performed at a temperature higher than that in FIG. 8, the grains of Nd fluoride as shown by portions B and C in FIG. 9 were obtained. The grains were about 200 nm in size, which is greater than the grain (portion A) shown in FIG. 8. EDX analysis profiles of the grains B and C are shown in FIGS. 7C, 7D, and 7E, which correspond to the compositions of the grain in encircled areas numbered 3 and 4, and 5, respectively, of the portions B and C. EDX profiles shown in FIGS. 7C to 7E indicate that in each profile Fe is found in an abundance of 1 atomic % or more. The grains are NdF₂ grains and hence it is conceivable that Fe atom substitutes in a crystal lattice of NdF₂. When the molding temperature was further increased, the crystal grain boundary became unclear as shown in FIG. 10, and also a sample having an average grain size of 500 nm were obtained. EDX analysis profiles of the grains D, E, and F are shown in FIGS. 7F, 7G, and 7H, respectively, which corresponds to the compositions of the grains in encircled areas numbered 6, 7, and 8, respectively. Also, diffraction images of the areas D, E, and F are shown in FIG. 10. The diffraction images of the areas D and F are broad patterns like the diffraction image of an amorphous material. The concentrations of Fe atom in the areas D and F are such that the peak of Fe is higher than the peak of Nd in a range of 4.0 keV to 8.0 keV corresponding to FIGS. 7F, and 7H. On the other hand, the diffraction image indicates that the area E is NdF₂ and the concentration of F₃ in this portion is lower than that of the amorphous portion. In the areas D and E, the concentration of Fe is higher than atomic 50% while in the area F, the concentration of Fe is less than 50%. From this it follows that the growth a layer in which the concentration of Fe is 50% or more having a structure close to an amorphous material can be suppressed by controlling the concentration of Fe in the fluorine compound or the fluorine compound layer to a certain level. Conditions of heating and compression to attain this include low temperature compression or short time molding, low oxygen molding. By decreasing the concentration of Fe in the fluorine compound layer to a level of 50 atomic % or less, the shape of demagnetization curve can be made smaller, for example, from a recoil permeability of 1.04 down to 1.30.

### Example 5

Hydrogen-treated rapidly quenched powder consisting mainly of Nd₂(Fe,Co)₁₄B is prepared as the NdFeB series powder. On the surface of grains of the powder is formed a fluorine compound. In the case of NdF₃-coating forming process, a translucent sol-like solution of NdF₃ having an NdF₃ concentration of 1 g/10 ml is used. The coated magnetic powder was prepared as follows.

(1) To 100 g of rare earth magnet magnetic powder having an average grain size of 70 μm to 150 μm was added 15 ml of a NdF₃-coating formation treatment liquid and mixed until the whole rare earth magnet magnetic powder got wetted with the liquid.

(2) The NdF₃-coating formation-treat rare earth magnet magnetic powder in (1) above was subjected to solvent elimination under a reduced pressure of 2 torr to 5 torr to remove methanol.

(3) The solvent-eliminated rare earth magnet magnetic powder in (2) above was transferred to a quartz boat and heat treated at a reduced pressure of 1×10⁻⁵ torr at 20000 for 30 minutes or at 400° C. for 30 minutes.

The film thus formed was examined by XRD. The results of XRD indicate that the fluorine compound film was constituted by NdF₃, NdF₂, NdOF and so on. The powder having a grain size of 70 μm to 150 μm was heated at a temperature of 500° C. and lower than 1,100° C. while preventing oxidation to form a high resistance layer on the surface of grains of the powder. When the grain size is less than 1 μm, the powder is susceptible to oxidization and their magnetic characteristics tend to be deteriorated. When the grain size is larger than 300 μm, magnetic characteristics improving effect of the fluorine compound formation including the effect of increasing resistance or other effects are weakened. To obtain magnetic characteristics, the magnetic powder is charged into a mold and preformed in a magnetic field at a compressive load of 2 t/cm², and then sintered at a temperature of 500° c. or higher and 1,100° C. or lower in the mold without exposing the powder to atmosphere. As a result, the obtained molding had a remanence of 1.0 T or more and 1.4 T or less and a high resistance magnet having a specific resistance of 0.2 mΩcm to 2 mΩcm is obtained. The squareness of a demagnetization curve of a molding depends on conditions of orienting the magnetic powder, sintering conditions, and conditions of forming the fluorine compound. In addition, the inclination of the demagnetization curve of the molding in the vicinity of zero magnetic field depends on a degree of dispersion of the orientation of the c-axis and the structure and composition in the vicinity of the boundary between the fluorine compound and the magnetic powder. In the case of the molding having a density of 90 to 99%, the layer of the fluorine compound coalesces with, disperses in, and causes grain growth in the molding and the fluorine compound layer on the surface of the magnetic powder serves as a binder in the molding and is partially sintered. When the thickness of the fluorine compound film was about 500 nm, the grain size of the fluorine compound immediately after the formation of the fluorine compound on the magnetic powder is 1 nm to 30 nm. In contrast, the grain size of the fluorine compound in the molding is 10 nm to 500 nm. There are found many portions where the fluorine compound layers formed on surfaces of different magnetic powder grains bind to each other and crystal grains grow to be sintered therein. It is found that there is iron in the crystals of the fluorine compound that has undergone grain growth. Since the iron does not exist in the fluorine compound before the grain growth, it is considered that the iron has migrated by diffusion from the magnetic powder upon grain growth. It can be presumed that along with the diffusion of iron, rare earth elements and oxygen that is present on the surface of the magnetic powder from the beginning could also diffuse. The fluorine compound in which iron is diffused is in the form of more often NdF₂ than NdF₃. The concentration of iron in the fluorine compound measured by EDX analysis is in average 1% or more and 50% or less. The composition containing iron in the vicinity of 50% based on the total mass of the composition is amorphous. Since oxygen was also contained, the molding contained NdF₂, NdF₃, Nd(O, F), and NdFeFO amorphous materials as well as NdFeB magnetic powder having a matrix of Nd₂Fe₁₄B. It was found that the fluorine compound and the oxide fluoride compound contain in average 1% to 50% of iron. Although it is unclear which sites iron atoms are arranged on in the fluoride compound and the oxide fluoride compound, it is presumed that iron is substituted at sites of fluorine or rare earth elements. Both the above-mentioned high remanence and high specific resistance can be achieved by forming a fluorine compound layer on R—Fe—X (where R represents a rare earth element, and X represents a third element) or R-T compound (where R represents a rare earth element, T represents Fe, Co, or Ni)₁ allowing grains to grow in the fluorine compound to diffuse and react with the matrix, and sintering the fluorine compound layer to form a binder. Examples of such a fluorine compound include RFₙ (where n is 1 to 3) constituted by at least one element R selected from elements consisting of Li, Mg, Ca, 3d transient elements, and rare earth elements and fluorine, containing 1% to 50% of iron from the magnetic powder by the thermal forming. If the concentration of iron in the fluorine compound is higher than 50 atomic %, e.g., 50 atomic % to 80 atomic %, a portion of the fluorine compound layer becomes amorphous and there is a possibility that the magnetic characteristics are deteriorated. Accordingly, it is necessary to select conditions of thermal forming and conditions of formation of the fluorine compound such that the concentration of iron in the fluorine compound is 50% or less. For each of various types of NdFeB series magnetic powder, an NdF₃ film or an NdF₂ film was formed on the surface of the magnetic powder and the resultant magnetic powder was thermally formed to obtain a sample having a density of 95% to 98%. The samples were evaluated for magnetic loss at a frequency of 1 kHz. The results obtained were analyzed into eddy current loss and hysteresis loss. FIG. 6 shows relationships among each loss, recoil permeability, and specific resistance. When the recoil permeability increases, the loss does not decrease even when the specific resistance is high. The range of recoil permeability in which loss can be decreased is 1.04 to 1.30. When the recoil permeability is above 1.30, the loss is higher than that of the NdFeB molding that had neither NdF₅ film nor NdF₂ film. When the thickness of the fluorine compound layer is made large in order to increase the specific resistance thereof and the magnetic powder is thermally formed at a high temperature, for example, at 800° C. or higher, Fe diffuses to increase a soft magnetic component, so that the recoil permeability increases. This leads to an increase in hysteresis loss, which in turn increases the total loss. In order to prevent the recoil permeability from increasing, it is necessary to prevent Fe from diffusing in the fluorine compound to an amount of 50% or more. Therefore, in order to obtain low loss, it is desirable to perform low temperature molding also in a molding temperature range of from 500° C. to 800° C. to make the thickness of the fluorine compound layer to 300 nm or less, so that Fe can be prevented from diffusing in the fluorine compound layer.

### Example 6

Explanation is made on a case in which the surface of the NDFEB series sintered magnet is cleaned by, for example, acid pickling to remove oxides and then NdF₃ is formed on the cleaned surface of the sintered magnet. Nd(CH₃COO)₃ used as a material of a treatment liquid is dissolved in H₂O and HF is added to the obtained solution. Addition of HF gives rise to gel-like or gelatinous NdF₃.XH₂O, which is centrifuged to remove the solvent. The resultant is coated on the NdFeB sintered body. The solvent of the coating film is evaporated and the hydrated water is evaporated by heating. The film thus formed was examined by XRD. The results of the XRD indicate that the film of the fluorine compound is constituted by NdF₃, NdF₂, and NdOF and so on. The sintered body is heated at a temperature of 350° C. or higher and 700° C. or lower while preventing oxidation to form a high resistance layer on the surface of the sintered body. By stacking such a magnet having formed on the surface thereof a high resistance layer, eddy current loss that will occur when the magnet is exposed to a high-frequency magnetic field can be decreased. The fluorine compound layer generates heat when irradiated with millimeter waves. Accordingly, when the sintered magnet on which the fluorine compound layer is formed is bonded, the fluorine compound layer can be selectively heated by irradiation of millimeter waves thereto to effect bonding. Therefore, heating of the central portion of the sintered body is suppressed, so that reaction between the rare earth element or matrix constituting elements and the fluorine compound in the fluorine compound can proceed. With the irradiation of millimeter waves, Fe atoms diffuse in the fluorine compound layer to a concentration of 1 atomic % in average. It is possible to bond the magnets by selective heating of the fluorine compound. Thus, a low loss sintered magnet can be produced by slicing a sintered magnet having formed thereon a high resistance layer containing the fluorine compound to obtain sliced magnets having a magnet thickness of 0.1 mm to 10 mm and selectively heating the sliced magnets by irradiation of millimeter waves. The fluorine compound with which the sintered magnet can be treated include materials consisting mainly of RFn (wherein n is 1 to 3, and R represents an alkali element, alkaline earth element, or a rare earth element) that contains at least one element selected from the group consisting of alkali elements, alkaline earth elements, and rare earth elements. By the irradiation of millimeter waves or micro waves after the treatment, the fluorine compound or the fluorine compound containing Fe grows. The above method can be applied to sintered magnets having various dimensions and is particularly effective to improve the magnetic characteristics of sintered magnet containing a layer deteriorated by working and is also effective to small magnets having a thickness of 1 mm or less.

### Example 7

Rapidly quenched powder consisting mainly of Nd₂(Fe,Co)₁₄B is prepared as the NdFeB series powder. On the surface of grains of the powder is formed a fluorine compound. Also, the fluorine compound is formed on the surface of grains of an Fe series soft magnetic powder. The NdFeB series magnetic powder and the Fe series magnetic powder are separately preformed, and then at least two performs are simultaneously subjected to thermal formation, so that molding including a soft magnetic body and a hard magnetic body can be produced. This enables production of low loss magnetic circuit components. In the case where a high resistance film of NdF₃ is formed on the surface of grains of the rapidly quenched magnetic powder, Nd(CH₃COO)₃ used as a material of a treatment liquid is dissolved in H₂O and HF is added to the obtained solution. Addition of HF gives rise to gel-like or gelatinous NdF₃.XH₂O, which is centrifuged to remove the solvent. The resultant is mixed with the NdFeB powder. Similarly, the resultant is mixed with the Fe series magnetic powder. The solvent of the coating film is evaporated and the hydrated water is evaporated by heating. The film thus formed was examined by XRD. The results of the XRD indicate that the film of the fluorine compound is constituted by NdF₃, NdF₂, and NdOF and so on. It was confirmed that due to these phases, both the NdFeB series magnetic powder and the Fe series magnetic powder had high magnetic powder resistances. When the NdFeB series magnetic powder whose grains have formed thereon the fluorine compound layer is deformed at 500° C. to 750° C., the magnetic powder exhibits anisotropy to increase the magnetic characteristics. The Fe series magnetic powder exhibiting soft magnetism whose grains have formed thereon the fluorine compound layer are also moldable in the above-mentioned temperature range can have a decreased hysteresis loss and maintain high resistance, so that eddy current loss can also be decreased when subjected to heat treatment for strain relaxation after the molding. The molding at 500° C. to 750° C. makes it possible to maintain magnetic characteristics at a density of 90% to 99% since at such temperatures both the NdFeB series magnetic powder and the Fe series magnetic powder whose grains having formed on the surface thereof the fluorine compound layer can be press molded while maintaining high resistance and magnetic characteristics. In this case, the fluorine compound grains present between the NdFeB series magnetic powder and the Fe series magnetic powder deform, diffuse, and bind with each other to form molding. Use of the fluorine compound can decrease a difference in thermal expansion coefficient. This is different from the anisotropy-imparting process using a magnetic field, so that both the magnets can be molded simultaneously. Depending on the shapes of components, the magnet can be produced by first molding the NdFeB series magnet powder, then molding the Fe series magnetic powder at a temperature near room temperature, and finally performing heat treatment for strain relaxation.

### Example 8

After forming a Ta subbing layer having a thickness of 10 nm or more on a glass substrate by a sputtering method, an NdFeB series thick film having a thickness of 10 μm to 100 μm was prepared thereon. When DyF₃ is to be formed on the surface of the grains of the rapidly quenched powder, Dy(CH₃COO)₃ used as a material is dissolved in H₂O and HF is added to the obtained solution to form gel-like or gelatinous NdF₃—XH₂O, which then is centrifuged. The resultant is coated on the surface of the thick film. Thereafter, the solvent is removed and the hydrated water is evaporated by heating. As a result, DyF₃ or DyF₂ grows on the surface of the NdFeB thick film. The thickness of the fluorine compound is 1 nm to 100 nm. Then, millimeter waves or microwaves are irradiated to the fluorine compound film to heat the fluorine compound to cause Dy and F atoms to diffuse through the surface of the NdFeB film. As the substrate, there can be used SiO₂ glass, which is difficult to be heated by irradiation of the millimeter waves or microwaves. Simultaneously with the diffusion of Dy and F, Fe and Nd also diffuse, so that 1 atomic % of Fe is observed in the fluorine compound and coercivity and squareness of NdFeB increase. As a result, a thick film magnet having a remanence of 0.7 T to 1.1 T and a coercivity of 10 kOe to 20 kOe can be obtained.

### Example 9

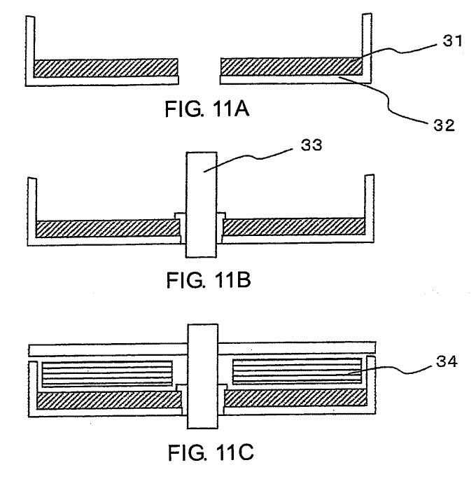

As shown in FIGS. 11A to 11C, a permanent magnet 31 is arranged in contact with a soft magnetic material 32. The permanent magnet 31 has a thickness of 1 μm to 1 mm. To increase the magnetic characteristics of the permanent magnet 31 of this thickness, surface treatment with the fluorine compound is performed on the surface of the permanent magnet 31 and then the fluorine compound grains having a grain size of 1 nm to 100 nm are grown on the surface of the permanent magnet 31 and further subjected to heat treatment at 400° C. to 800° C. to increase coercivity of the magnet. The permanent magnet may be either a thick film magnet or a sintered magnet. A shaft 33 is inserted in a hole provided in the center of the permanent magnet 31 and the soft magnetic material 32, and then a coil 34 is arranged above the permanent magnet 31. The above-mentioned heat treatment may be performed by irradiation of millimeter waves.

### Example 10

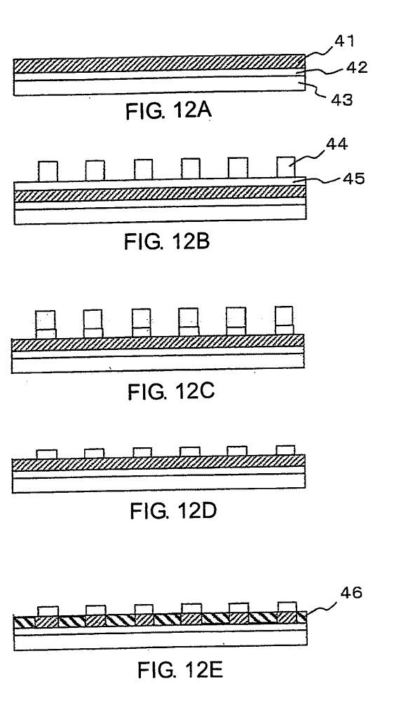

FIGS. 12A to 12E illustrate a process of forming a magnetic film. As shown in FIG. 12A, a Ta subbing layer 42 having a thickness of 1 nm to 100 nm is formed on a SiO₂ substrate 43 by sputtering and an NdFeB film 41 having a thickness of 10 nm to 1,000 nm is formed on the subbing layer 42. On the NdFeB film 42, a centrifuged gel-like or gelatinous solution DyF₃.XH₂O containing iron ions is coated by using a spinner to form a thick film having a uniform thickness (1 nm to 1,000 nm) to form a fluorine compound layer 45. On the fluorine compound layer 45 is coated a resist 44 and after exposure through a mask and development, the resist 44 remains along the mask used as shown in FIG. 125. Then, an uncovered portion of the fluorine compound layer 45 was removed by, for example, milling to form a structure as shown in FIG. 12C, followed by removing the resist with an organic solvent or the like to obtain a film structure as shown in FIG. 12D. In this state, the obtained film structure is subjected to heat treatment by irradiation of millimeter waves. For the heating by irradiation of millimeter waves, a 28 GHz millimeter wave heating apparatus manufactured by FUJI DEMPA KYOGYO Co., Ltd. was used to heat the fluorine compound selectively. With this heating, diffusion occurs between the fluorine compound layer and the NdFeB film that contacts the fluorine compound layer and a reaction layer 46 grows to change the magnetic characteristics of the NdFeB. The reaction layer 46 may be present on only the boundary with the fluorine compound layer 45. The change in magnetic characteristics may vary depending on the type of the fluorine compound to be used. When the fluorine compound DyF₃ or TbF₃ is used, changes in the magnetic characteristics such as an increase in coercivity or suppression of thermal demagnetization of the NdFeB film in the vicinity of the contacting portion can be confirmed. In this manner, the magnetic characteristics of the magnet can be changed such that the magnetic characteristics of only the portion of the NdFeB film that contacts the fluorine compound are increased and the area of the contacting portion can be changed by controlling the size of the resist pattern, so that a fine pattern of a submicron order to a larger pattern can be coped with. The change in magnetic characteristics in only the contacting portion can be performed not only in the NdFeB magnetic film but also in magnetic films such as Fe series magnetic films including FePt, FeSiB, and NiFe magnetic films, or Co series magnetic films including CoFe and CoPt magnetic films. In addition, use of millimeter waves makes it possible to heat only the portion in the vicinity of the fluorine compound while suppressing heating of the substrate. It is possible to shorten ordinary heat treatment time by forming the fluorine compound film all over the magnetic film and irradiating millimeter waves and also it is possible to perform standardizable heat treatment without using subbing layers. Such a technique can be used in localized heating in processes for producing not only magnetic recording media but also magnetic heads. Similarly to the aforementioned, after forming a Ta subbing layer having a thickness of 10 nm or more on a glass substrate by sputtering, an NdFeB thick film having a thickness of 10 μmm to 100 μm is fabricated. When DyF₃ is to be formed on the surface of the NdFeB thick film, Dy(CH₃Coo)₃ used as a material is dissolved in H₂O and HF is added to the obtained solution to form gel-like or gelatinous NdF₃—XH₂O, which then is centrifuged. The resultant is coated on the surface of the thick film. Thereafter, the solvent is removed and the hydrated water is evaporated by heating. As a result, DyF₃ or DyF₂ grows on the surface of the NdFeB thick film. The thickness of the fluorine compound is 1 nm to 100 nm. The fluorine compound layer may be formed by a sputtering method or a vapor deposition method. Then, millimeter waves or micro waves are irradiated to the fluorine compound film to heat the fluorine compound to cause Dy and F atoms to diffuse through the surface of the NdFeB film. As the substrate, there can be used SiO₂ glass, which is difficult to be heated by irradiation of the millimeter waves or microwaves. Simultaneously with the diffusion of Dy and F, Fe and Nd also diffuse, so that 1 atomic % of Fe is observed in the fluorine compound and coercivity and squareness of NdFeB increase. As $ a result, a thick film magnet having a remanence of 0.7 T to 1.1 T and a coercivity of 10 kOe to 20 kOe can be obtained.

### Example 11

The process of forming rare earth fluoride compound-coated or alkaline earth metal fluoride compound-coated film on a soft magnetic plate was performed by the following method.

(1) A treatment liquid for forming a neodymium fluoride compound film was prepared as follows. That is, first, salt containing Dy having high solubility in water was mixed with water and stirred until dissolution. Diluted hydrofluoric acid was slowly added to the resultant solution. The solution in which gel-like or gelatinous precipitate of the fluorine compound was formed was further stirred. The mixture was centrifuged and then methanol was added. Further, the methanol solution was stirred to obtain a methanol solution in which corrosive ions were diluted, which solution was used as a treatment liquid.

(2) The NdF₃ coating film formation treatment liquid was dripped on a soft magnetic plate and it was determined whether or not the soft magnetic plate was wetted with the treatment liquid. The treatment liquid was mixed until it was confirmed that the wetting occurred.

(3) The NdF₃ coating film formation-treated soft magnetic plate from which the solvent was removed was heat treated under a reduced pressure of 1×10⁻⁵ torr at 200° C. for 30 minutes or at 400° C. for 30 minutes.

The soft magnetic plate is a sheet-like amorphous material or iron, Co, or Ni ferromagnetic material, such as a magnetic stainless steel sheet. After forming the fluorine compound on such a soft magnetic plate, the fluorine compound-formed soft magnetic plate is heated by irradiation of millimeter waves to enable to heat only a portion of the soft magnetic plate that contacts the fluorine compound. By forming the fluorine compound layer on a part of the soft magnetic plate, only the part of the soft magnetic plate on which the fluorine compound is formed can be locally heated by irradiation of millimeter waves thereto. By partially heating in order to decrease hysteresis loss of the amorphous material, the mechanical strength can be retained in non-heated portions and the heated portions can be made low loss, so that the strength and loss are well balanced. In the magnetic stainless steel sheet, heating by irradiation of millimeter waves only at the portion coated with the fluorine compound makes it possible to convert only the heated portion from ferromagnetic to non-ferromagnetic or vice versa so that this technology can be applied to a rotating machine utilizing reluctance torque.

### Example 12

When an NdFeB series sintered magnet block is worked by mechanical polishing a work-affected layer is formed on a surface thereof that deteriorates the magnetic characteristics of the magnet. On the surface of 10×10×10 mm NdFeB sintered magnet block, there occur minute cracks due to the mechanical polishing. A portion of the cracked surface is oxidized. Such an oxide includes rare earth elements and iron that are constituent elements of the sintered magnet, and magnetization tends to be reversed. This causes a decrease in magnetic characteristics such as a decrease in remanence or coercivity. Such a decrease in magnetic characteristics causes weakening of resistance to demagnetization of the magnet and hence there arises a problem when the magnet is used at high temperatures or in a high demagnetization field. As an effective method of recovering the magnetic characteristics of a magnet, a technique of covering the magnet with a solution of rare earth fluorine compound. The rare earth fluoride compound solution is a solution or colloid solution obtained by dissolving, for example, Dy acetate or Dy nitrate in water with stirring, centrifuging the resultant solution and adding methanol to the supernatant. The technique in which such as solution or colloid solution is coated on a sintered magnet block and the coated magnet block is heat treated has the following advantages as compared with the case where pulverized powder of the fluorine compound or the like is coated on the magnetic powder:

1) Since a liquid is used, the surface with cracks can be readily covered.

2) Since a liquid is used, not only a surface with various sizes of cracks can be covered but also hollow portions and holes in the surface can pool the solution.

3) Since a liquid is used, the fluorine compound can contact the magnet surface to surface, so that the heat treatment can be performed at lower temperatures in shorter times.

4) Impurities such as carbon in the solution tend to be incorporated by heat treatment into the magnet together with the rare earth element or fluorine atoms.

5) Since a liquid is used, the thickness of the coating can be controlled without difficulty, so that thinning of the coating is easy to attain.

6) It is possible to mix various elements in the solution.

7) It is possible to coat the fluorine compound uniformly by using, for example, a spinner and the solution can be reused.

8) A problem specific to powder material, such as agglomeration of fine grains, does not occur, so that the coating can be performed uniformly.

9) By using solutions of different species of fluorine compound in combination with heat treatment, a multi-stage process (treating with an Nd fluoride compound solution, heat treatment, treating with other heavy rare earth fluoride compound solution, and then heat treatment) can be realized.

Even when Dy acetate is used and an almost transparent DyF solution is coated to an average thickness of 10 nm on a sintered magnet block, inside of cracks extending from the surface of the sintered magnet block in the direction of depth can be coated with the DyF solution. In this case, if there are holes in the inside of the crack, fine holes can be filled with the solution. Since the DyF solution contacts the surface of the magnet by surface contact, diffusion of rare earth and impurities tend to occur at lower temperatures. Since film thickness distribution of the solution coating is more uniform than that obtained by powder coating, it is easy to decrease the amount of rare earth elements to be diffused. When the solution contains a light weight element other than the rare earth elements, the light weight element tends to be diffused together with the Dy, which is a rare earth element, and fluorine upon heat treatment and tends to remain in a portion of the grain boundary. The light weight element includes, for example, carbon and oxygen. The carbon atoms mixed in the solution diffuses together with the rare earth element and fluorine atom from the cracks, the surface, parts near the grain boundary of the NdFeB sintered magnet block into the inside thereof. Therefore, carbon is detected to be present on the grain boundary or on the surface of the sintered magnet block by, for example, EDX. After the DyF solution is coated to an average thickness on a flat portion of 100 nm, Dy and F (fluorine) or C (carbon) diffuse along interfaces such as grain boundaries simultaneously with removal of the solvent. On the outermost surface of the magnet block, carbon-containing rare earth oxide fluoride compound such as (Nd, Dy) (O, F, C), Dy fluoride, or Dy oxide grows to a thickness of 1 nm to 100 nm. As the heat treatment temperature increases, Dy and light weight elements come to diffuse in the inside of the magnet block. At the heat treatment temperature of 500° C. or higher, mutual diffusion of Dy and Nd occurs and a Dy-rich phase is formed in the vicinity of the grain boundary. Some of Nd atoms combine with carbon or oxygen to be fixed to the grain boundary and Dy is distributed in a rage of 1 nm to 200 nm from the grain boundary. Presence of carbon causes mutual diffusion of Nd and Dy in the grain boundary part to readily occur and helps Dy remain in the vicinity of the grain boundary. This indicates that as compared with use of the fluorine compound powder, use of the solution of the fluorine compound leads to an increased rare earth fixing effect by light weight elements in the solution, making it possible to increase coercivity and Hk as well as to increase remanence at the same coercivity. At triple junctions of grain boundary, there is found a phase in which Dy, carbon, and fluorine have segregated. As described above, the effect of fixing a rare earth element (Dy) to a portion in the vicinity of grain boundary by the light weight element impurities in the solution has been confirmed as the feature of the use of the solution. Use of the DyF solution and methanol, ethanol or the like as a solvent results in that a fluoride compound or an oxide fluoride compound with a high concentration of carbon grows in the boundary from the surface toward inside of the sintered magnet block, diffusion proceeds between the carbon-containing compound and the rare earth element that constitutes the magnet, Dy diffuses to the vicinity of the grain boundary, and Nd and Dy are contained in the carbon-rich compound. As compared with the case in which fine powder fluorine compound is coated on the surface of a sintered magnet block and then Dy is diffused to the vicinity of the grain boundary by heat treatment, use of the present technique more effectively helps grain boundary diffusion of Dy and also more effectively helps mutual diffusion of Dy and Nd. In addition, the solution treatment requires a shorter time for diffusion than the powder treatment since the solution enters into fine cracks in the sintered magnet block, so that the amount of rare earth element required for the treatment can be decreased and also diffusion length can be increased. On the surface of the sintered magnet block, there are formed at the grain boundary or in the vicinity of the grain boundary rare earth fluoride or rare earth oxide fluoride each containing carbon in an amount that can be observed by EDX while in the central part of the magnet block carbon in an amount that can be observed by EDX is not present. The rare earth fluoride compound or rare earth oxide fluoride compound grows in the form of granules or laminae. In the rare earth fluoride compound or rare earth oxide fluoride compound, Dy segregates. A portion of Dy also segregates inside the grain. It is confirmed that the growth of the fluoride compound or oxide fluoride compound containing carbon and a rare earth element such as Nd or Dy and concomitant diffusion of Dy to the vicinity of the grain boundary result in an increase in coercivity, an increase in squareness, a decrease in temperature coefficient of magnetic characteristics, a decrease in amount of rare earth element to be used, a decrease in thermal demagnetization or a decrease in eddy current.

### Example 13

A fluoride compound solution was prepared as follows. First, Dy acetate or Dy nitrate was dissolved in water and hydrofluoric acid was slowly added thereto to obtain a gel-like or gelatinous precipitate solution. After this was stirred and centrifuged, methanol was added and the mixture was stirred. Further, the mixture was centrifuged and then ethanol was added, followed by further stirring the mixture. In the obtained ethanol solution was soaked an NdFeB sintered magnet block (10×10×10 mm), which then was dried and heat treated, so that Dy could be diffused in the inside of the NdFeB sintered magnet along the grain boundary. The heat treating temperature was 500° C. or higher, preferably 800° C. or higher. With this heat treatment, hydrogen, carbon, oxygen or nitrogen derived from the solution diffused in the sintered magnet block together with fluorine and Dy, so that on the surface of the sintered magnet block, there is formed an Nd fluoride compound that contains such a light weight element and Dy in large amounts. Since the liquid is used, the solution penetrate to crack portion having a width of 1 nm or depression and protrusion portion and since such a fluoride compound is formed at low temperatures, the fluoride compound readily grows on the portion where the magnetic characteristics were deteriorated by working as compared with the case where powder is used, so that the magnetic characteristics can be improved with a small usage of rare earth element. In a portion of the grain boundary inside the magnet (Dy, Nd)ₓ(O, F, C)_{y} grows (where x and y are positive integers). In the vicinity of the fluoride compound or oxide fluoride compound containing a light weight element such as carbon, Dy segregates and there occurs exchange between Nd and Dy by diffusion. The carbon atoms contribute to segregation of Dy, stability of the fluoride compound or oxide fluoride compound, and exchange between Nd and Dy, and so on. It has been confirmed that by coating the above-mentioned treatment liquid in an amount of 0.5 vol % and drying and heat treating, the coercivity increased by 50%. Besides the increase in coercivity, an increase in squareness of a demagnetization curve, improvement of temperature characteristics, and an increase in mechanical strength were confirmed. Because of ionic components contained in the treatment liquid, it is possible to form the oxide fluoride compound while removing the oxides on the surface of the sintered magnet, so that acid pickling before the treatment is unnecessary. By using a treatment liquid having a low viscosity, the solution can be charged in a gap of 1 nm to 10 nm wide. As compared with the case where fine powder is used, this shortens time and lowers temperature for forming the fluoride compound, the oxide fluoride compound, or the oxide fluoride compound containing carbon on the grain boundary and diffusing Dy therein.

### Example 14

A fluoride compound solution was prepared as follows. First, Dy acetate or Dy nitrate was dissolved in water and iron ions were added. Then, hydrofluoric acid was slowly added thereto to obtain a gel-like or gelatinous precipitate solution. After this was stirred and centrifuged, methanol was added and the mixture was stirred. Further, the mixture was centrifuged and then ethanol was added, followed by further stirring the mixture. In the obtained ethanol solution was soaked an NdFeB sintered magnet block (10×10×10 mm), which then was dried and heat treated, so that Dy could be diffused in the inside of the NdFeB sintered magnet along the grain boundary. The heat treating temperature was 500° C. or higher, preferably 800° C. or higher. With this heat treatment, hydrogen, carbon, oxygen, nitrogen, or iron derived from the solution diffused in the sintered magnet block together with fluorine and Dy, so that on the surface of the sintered magnet block, there is formed an Nd fluoride compound that contains such a light weight element or iron and Dy in large amounts. Since the liquid is used, the liquid penetrates to crack portion having a width of 1 nm and since such a fluoride compound is formed at low temperatures, the fluoride compound readily grows on the portion where the magnetic characteristics were deteriorated by working as compared with the case where powder is used, so that the magnetic characteristics can be improved with a small usage of rare earth element. In a portion of the grain boundary inside the magnet (Dy, Nd)ₓ(O, F, C)_{y} (where x and y are positive integers) grows. In the vicinity of the fluoride compound or oxide fluoride compound containing a light weight element such as carbon, or iron, Dy segregates and there occurs exchange between Nd and Dy by diffusion. The carbon atoms or iron atoms contribute to segregation of Dy, stability of the fluoride compound or oxide fluoride compound, and exchange between Nd and Dy, and so on. It was confirmed that by coating the above-mentioned treatment liquid in an amount of 0.5 vol % and drying and heat treating, the coercivity increased by 50%. Besides the increase in coercivity, an increase in squareness of a demagnetization curve, improvement of temperature characteristics, and an increase in mechanical strength were confirmed. Because of ionic components such as acetate besides iron contained in the treatment liquid, it is possible to form the oxide fluoride compound while removing the oxides on the surface of the sintered magnet, so that acid pickling before the treatment is unnecessary. By using a treatment liquid having a low viscosity, the solution can be charged in a gap of 1 nm to 10 nm wide. As compared with the case where fine powder is used, this shortens time and lowers temperature for forming the fluoride compound, the oxide fluoride compound, or the oxide fluoride compound containing 1 ppm or more of carbon on the grain boundary and diffusing Dy therein.

### Example 15

A fluoride compound solution was prepared as follows. First, Dy acetate or Dy nitrate was dissolved in water and iron ions were added. Then, hydrofluoric acid was slowly added thereto to obtain a gel-like or gelatinous precipitate solution. After this was stirred and centrifuged, methanol was added and the mixture was stirred. Further, the mixture was centrifuged and then ethanol was added, followed by further stirring the mixture. In the obtained ethanol solution was soaked one to thousand NdFeB sintered magnet blocks (10×10×10 mm) simultaneously when there were plural blocks, and the block or blocks were dried and heat treated, so that Dy and iron could be diffused in the inside of the NdFeB sintered magnet along the grain boundary. The heat treating temperature was 500° C. or higher, preferably 800° C. or higher. With this heat treatment, hydrogen, carbon, oxygen, nitrogen, or iron derived from the solution diffused in the sintered magnet block together with fluorine and Dy, so that on the surface of the sintered magnet block, there is formed an Nd fluoride compound that contains such a light weight element or iron and Dy in large amounts. Since the liquid is used, the liquid penetrates to crack portions having a width of 1 nm and since such a fluoride compound is formed at low temperatures, the iron-containing fluoride compound readily grows on the portion where the magnetic characteristics were deteriorated by working as compared with the case where powder is used. This enables the magnetic characteristics to be improved with a small usage of rare earth element. In a portion of the grain boundary inside the magnet (Dy, Nd)ₓ(O, F, C)_{y} (where x and y are positive integers) grows. In the vicinity of the fluoride compound or oxide fluoride compound containing a light weight element such as carbon, or iron, Dy segregates and there occurs exchange between Nd and Dy by diffusion. The carbon atoms or iron atoms contribute to segregation of Dy, stability of the fluoride compound or oxide fluoride compound, and exchange between Nd and Dy, and so on. It was confirmed that by coating the above-mentioned treatment liquid in an amount of 0.01 vol % to 1 vol % and drying and heat treating, the coercivity increased by 50%. Besides the increase in coercivity, an increase in squareness of a demagnetization curve, improvement of temperature characteristics, an increase in mechanical strength, and an increase in local electric resistance were confirmed. The treatment liquid can form fluoride compound containing besides Dy one or more other rare earth elements or alkaline earth elements. By treating a sintered magnet block with the treatment liquid to which 1 wt- to 50 wt % of fine power of rare earth fluoride compound or rare earth oxide fluoride compound having a grain size of 0.01 μm to 1 μm was added and performing the above-mentioned heat treatment or performing heat treatment at 800° C. or higher and heat treatment at 800° C. or lower, the magnetic characteristics of the sintered magnet can be increased. The treatment liquids can be repeatedly used a desired number of times by circulating them with adjustment of composition. The treatment liquids can be prepared a material that is obtained by eluting constituent elements of sintered magnet with an acidic liquid. Such material can be obtained by recycling sintered magnets.

### Example 16

A fluoride compound solution was prepared as follows. First, Dy acetate or Dy nitrate was dissolved in water and hydrofluoric acid was slowly added thereto to obtain a gel-like or gelatinous precipitate solution. After this was stirred and centrifuged, methanol was added and the mixture was stirred. Further, the mixture was centrifuged and then ethanol was added, followed by further stirring the mixture. In the obtained ethanol solution was soaked an NdFeB sintered magnet block (10×10×10 mm), which then was dried and heat treated at 200° C. to grow a fluoride compound or an oxide fluoride compound containing Dy on the surface of the NdFeB sintered magnet. Then, by heat treatment at 500° C. or higher, preferably 800° C. or higher, hydrogen, carbon, oxygen, nitrogen derived from the solution diffused in the sintered magnet block together with fluorine and Dy, so that on the surface to the inside of the sintered magnet block, there is formed an Nd fluoride compound that contains such a light weight element and Dy in large amounts. Dy and fluorine or light weight elements diffuse from the fluoride compound to the inside of the magnet along the grain boundary. Since the liquid is used, the solution penetrates to crack portion having a width of 1 nm and since such a fluoride compound containing iron is formed at low temperatures, the fluoride compound readily grows on the portion where the magnetic characteristics were deteriorated by working as compared with the case where powder is used, so that the magnetic characteristics can be improved with a small usage of rare earth element. In a portion of the grain boundary inside the magnet (Dy, Nd)ₓ(O, F, C)_{y} (where x and y are positive integers) grows. In the vicinity of the fluoride compound or oxide fluoride compound containing a light weight element such as carbon, Dy segregates and there occurs exchange between Nd and Dy by diffusion. The carbon atoms contribute to segregation of Dy, stability of the fluoride compound or oxide fluoride compound, and exchange between Nd and Dy, and so on. It was confirmed that by coating the above-mentioned treatment liquid in an amount of 0.5 volt and drying and heat treating, the coercivity increased by 50%. Because of ionic components contained in the treatment liquid, it is possible to form the oxide fluoride compound while removing the oxides on the surface of the sintered magnet, so that acid pickling before the treatment is unnecessary. By using a treatment liquid having a low viscosity, the solution can be charged in a gap of 1 nm to 10 nm wide. As compared with the case where fine powder is used, this shortens time and lowers temperature for forming the fluoride compound, the oxide fluoride compound, or the oxide fluoride compound containing carbon on the grain boundary and diffusing Dy therein. It has been confirmed that by using a treatment liquid containing Nd and Tb fluoride compounds besides Dy fluoride compound, an increase in coercivity. It has also been confirmed that the alkaline earth fluoride compound solution increased squareness of demagnetization curve of the magnet. Therefore, in order to increase the magnetic characteristics, it is possible to repair deterioration of the magnet mainly caused by oxidation of the rare earth elements on the surface of the sintered magnet without using rare earth fluoride compound solutions, more particularly by using other fluoride compound solutions, so that fluorine atoms in the fluoride compounds, oxide fluoride compounds, or carbon-containing oxide fluoride compounds, such as (Nd, M)ₓF_{y}, (Nd, M)ₓF_{y}, (Nd, M)ₓ(f, O)_{y}, and (Nd, M)ₓ(F, OC)_{y} (where x and y are positive positive integers) and so on that diffuse and grow together with Nd can reduce the oxidation-affected portions.

### Example 17

A fluoride compound solution was prepared as follows. First, Mg acetate or Mg nitrate was dissolved in water and hydrofluoric acid was slowly added thereto to obtain a gel-like or gelatinous precipitate solution. After this was stirred and centrifuged, methanol was added and the mixture was stirred. Further, the mixture was centrifuged and then ethanol was added, followed by further stirring the mixture. In the obtained ethanol solution was soaked an NdFeB sintered magnet block (10×10×10 mm), which then was dried and heat treated at 200° C. to grow mg-containing fluoride or oxide fluoride on the surface of the NdFeB sintered magnet. The heat treating temperature was 500° C. or higher, preferably 800% C or higher. With this heat treatment, hydrogen, carbon, oxygen or nitrogen derived from the solution diffused in the sintered magnet block together with fluorine and Mg, so that on the surface of the sintered magnet block, there is formed an Nd fluoride compound that contains such a light weight element and Mg in large amounts. Since the liquid is used, the solution penetrates to crack portions having a width of 1 nm and since such a fluoride compound is formed at low temperatures, the fluoride compound readily grows on the portion where the magnetic characteristics were deteriorated by working as compared with the case where powder is used, so that the magnetic characteristics can be improved with a small usage of rare earth element. In a portion of the grain boundary inside the magnet (Mg, Nd)ₓ(O, F, C)_{y} grows (where x and y are positive integers). In the vicinity of the fluoride compound or oxide fluoride compound containing a light weight element such as carbon, Mg segregates and there occurs exchange between Nd and Mg by diffusion. The carbon atoms contribute to segregation of Mg, stability of the fluoride compound or oxide fluoride compound, and exchange between Nd and Mg, and so on. It was confirmed that by coating the above-mentioned treatment liquid in an amount of 0.5 vol % and drying and heat treating, the coercivity increased 10%. Improvement of temperature characteristics and an increase in mechanical strength have been confirmed. Because of ionic components contained in the treatment liquid, it is possible to form the oxide fluoride compound while removing the oxides on the surface of the sintered magnet, so that acid pickling before the treatment is unnecessary. When an (Nd, Dy)FeB magnet is used as the sintered magnet, Nd and Dy migrate into the fluoride compound or oxide fluoride compound that grows by reaction between the Mg fluoride compound and the rare earth element, and upon heat treatment Dy and Nd diffuse from the fluoride compound or oxide fluoride compound along grain boundary of the sintered magnet. It has been confirmed that this increases the magnetic characteristics such as an increase in coercivity and an increase in squareness of demagnetization curve. That is, it is possible to cover the surface of the sintered magnet with a fluoride compound treatment liquid containing no rare earth elements and heat the sintered magnet at a temperature in a range of 500° C. or higher and the sintering temperature or lower to grow a fluoride compound or oxide fluoride compound containing the constituent elements of the sintered magnet in the vicinity of the surface of the sintered magnet, and perform diffusion heat treatment of the to diffuse the rare earth element along the grain boundary, and diffuse Dy in the vicinity of the grain boundary by mutual diffusion between Dy and Nd. By this technique, it is possible to increase the magnetic characteristics of the surface of the sintered magnet by using the fluoride compound treatment liquid that contains no rare earth elements, and the squareness of demagnetization curve is increased by 10%. Both an increase in squareness of demagnetization curve and an increase in coercivity can be achieved by using a mixture of the Mg fluoride compound solution and the heavy rare earth fluoride compound solution or stacking layers of the Mg fluoride compound solution and the heavy rare earth fluoride compound solution one on another. Examples of fluoride compound solution that can exhibit the above-mentioned effects other than the Mg fluoride compound solution include solutions of fluorides of alkali, alkaline earth, and transient metal elements.

### Example 18

When an NdFeB sintered magnet is used for high heat resistant applications, heavy rare earth elements such as Dy, Ho, and Tb are added or semimetal elements such as Ga, or transient metal elements such as Nb is mixed. Such a sintered magnet contains a matrix RE₂Fe₁₄B (RE represents a rare earth element) and grain boundary phase and borides other than the matrix. During working polishing process, cracks and oxidation occur centered on the surface of or the grain boundary vicinity of the sintered magnet. Such an oxidation deteriorates the magnetic characteristics of the magnet. The crack part is a boundary that is nonmagnetic and uneven, so that reversed magnetic domain tends to occur, thus decreasing the squareness of demagnetization curve. When the fluoride compound solution contacts cracks of 1 nm to 1,000 nm wide or the surface of the sintered magnet, a portion of fluorine atoms combines with oxygen or a rare earth element on the boundary add if thermal energy is added thereto, the portion of the fluorine atoms diffuses from the boundary to grow rare earth fluorides or rare earth oxides fluorides and the oxides of rare earth element are reduced to fluorides or oxides fluorides of rare earth elements. Since liquid is used, this kind of reaction occurs all over the surface that the liquid contacts and growth of mainly the oxide fluoride compound is observed and a rare earth oxide fluoride compound phase grows in the vicinity of the surface of the sintered magnet. Almost simultaneously with this, atoms of fluorine, rare earth elements, or carbon in the liquid, and so on diffuse along grain boundary into the grains. It the width of the crack is 1,000 nm or less and the thickness of the oxide film is 100 nm or less, it in possible to increase squareness of demagnetization curve of the sintered magnet by surface treatment with, for example, Mg fluoride compound liquid that contains no rare earth element. That is, it is possible to recover the magnetic characteristics by reduction of the rare earth oxides. In the case of the sintered magnet in which a heavy rare earth element is used in advance, it is possible to grow a heavy rare earth oxide fluoride compound layer by heat treatment by using such an Mg fluoride compound liquid that contains no rare earth element, diffuse the heavy rare earth element from the oxide fluoride compound along the grain boundary, and segregate the heavy rare earth element in the vicinity of the grain boundary by exchange between the heavy rare earth element and Nd. On this occasion, light weight elements such as fluorine or carbon that diffuses at high rates in the liquid can be detected in the vicinity of the grain boundary. The rare earth elements are known to bind with carbon, boron, nitrogen, or oxygen to form respective compounds. It is possible to realize exchange reaction between a heavy rare earth element and a rare earth element utilizing a difference in free energy of formation of compounds. To increase the magnetic characteristics of the sintered magnet in whole, fluorine and rare earth elements are diffused along the grain boundary and fluorine and rare earth elements are segregated along the grain boundary. Grain boundary diffusion of rare earth elements is aided by light weight elements such as fluorine and carbon that form compounds with rare earth elements. When the rare earth element is diffused from the liquid, the liquid contacts the sintered magnet on its surface, the diffusion proceeds at low temperatures, and the light weight elements diffuse along the grain boundary to help the rare earth elements diffuse. This causes the fluoride compound containing a rare earth element, rare earth oxide fluoride compound, or rare earth carbon oxide fluoride compound, which grows along the grain boundary, to have a decreased grain size. By coating 0.1 vol % to 5 vol % Dy fluoride solution on a sintered magnet by use of the liquid and heat treating the sintered magnet at 500° C. to 1,000° C., the rare earth fluoride oxide compound and rare earth carbide oxide fluoride compound grows on the surface of the sintered magnet and the grain size thereof is 0.1 μm to 10 μm. The rare earth fluoride oxide compound or the rare earth carbon oxide fluoride compound that grows in the grain boundary inside the sintered magnet can have a grain size smaller than that at the outermost surface. The smaller the grain size of such rare earth fluoride oxide compound and rare earth carbon oxide fluoride compound is, the more preferred. When the grains grow along the grain boundary and the size of the grain is evaluated in the direction parallel to the grain boundary and in the direction perpendicular to the grain boundary, the size of the grain in the direction parallel to the grain boundary is longer than the size in the direction perpendicular to the grain boundary. This configuration of the grain contributes to an increase in coercivity. The concentration of fluorine in the rare earth fluoride oxide compound and rare earth carbon oxide fluoride compound is 0.1 atomic % to 50 atomic %. The concentration of carbon is 0.01 atomic t to 10 atomic %. The concentration of oxygen is 0.01 atomic % to 10 atomic %. Since the fluorine atoms and carbon atoms segregate in laminae along the grain boundary, the diffusion of the rare earth elements among them proceeds centered on the grain boundary toward the periphery to increase magnetic characteristics of the magnet. As the increases in the magnetic characteristics, there have been observed an increase in coercivity by 10% to 200% and an increase in squareness of demagnetization curve by 5% to 20%. As a result, an increase in resistance to demagnetization is observed. The proportion of the grain boundary vicinity having a concentration of fluorine of 0.1% or more to the total grain boundary is 10% or more, preferably 50% or more. The light weight element that diffused from the liquid, such as carbon, is observed to be abundant in the grain boundary part in the vicinity of the surface of the sintered magnet and the concentration of the light weight element shows a tendency of decreasing toward the inside of the sintered magnet. Such a light weight element that is capable of combining with rare earth elements, when present in the grain boundary, helps the rare earth element diffuse, and hence enables the heat treatment to occur at lower temperatures and in a shorter time and the magnetic characteristics to be increased because the light weight element helps the phase containing fluorine grow along the grain boundary. Therefore, causing carbon to exist in an amount of 1 ppm or more, preferably 100 ppm or more in the sintered block in advance helps the grain boundary diffusion of the rare earth element in the liquid, so that the heat treatment time can be shortened or the magnetic characteristics of the magnet can be increased. By utilizing carbon in the liquid, carbon in a concentration of about 1/10 to about 2 times the concentration of oxygen can be made to be present on the surface of the sintered magnet block. The carbon is diffused by the heat treatment after the treatment with the treatment liquid and diffuses into the inside of the magnet along the grain boundary. It has been confirmed that coating a solution containing a rare earth element and fluorine on a sintered magnet block and heat treating the coated sintered magnet block at a temperature of 1,000° C. or lower increases coercivity and squareness of demagnetization curve by 10% or more. Use of the solution has the following advantages.

1) Since a liquid is used, a surface with minute cracks having a width of 1 nm to 100 nm can be readily covered.

2) Since a liquid is used, not only surfaces of various sizes of cracks can be covered but also hollow portions and holes in the surfaces can pool the solution. Also, NdFeB grains that are likely to come off can be bound.

3) Since a liquid is used, the fluorine compound and rare earth elements can contact the magnet on its surface, so that the heat treatment can be performed at lower temperatures in shorter times.

4) Since the fluoride compound is swelled in an alcohol, impurities such as carbon in the solution tend to be incorporated by heat treatment into the magnet together with the rare earth element or fluorine atoms. This helps a phase containing fluorine in laminae to grow on the grain boundary.

5) Since a liquid is used, the thickness of the coating can be controlled without difficulty, so that thinning of the coating is easy to attain. A coating film having an average thickness of 1 nm to 1,000 nm can be formed without difficulty.

6) It is possible to mix various elements in the solution. The liquid can be mixed with light weight elements such as carbon (hydrogen, oxygen, nitrogen, etc.), various acid solutions, with fine powder of a rare earth fluoride compound, or fine powder of a rare earth nitride compound.

7) It is possible to coat the fluorine compound uniformly on a magnet having a complicated configuration by using, for example, a spinner and the solution can be reused.

8) A problem specific to powder material, such as agglomeration of fine grains, does not occur, so that the coating can be performed uniformly.

9) By using solutions of different species of fluorine compound in combination with heat treatment, a multi-stage process (treating with an Nd fluoride compound solution, heat treatment, treating with other heavy rare earth fluoride compound solution, and then heat treatment) can be realized. It has been confirmed that making full use of such characteristics, surface treatment on not only the sintered block but also NdFeB magnetic powder resulted in an increase in magnetic characteristics.

### Example 19

When an NdFeB sintered magnet is used for high heat resistant applications, heavy rare earth elements such as Dy, Ho, and Tb are added or semi-metal elements such as Ga, or transient metal elements such as Nb is mixed. Such a sintered magnet contains a matrix RE₂Fe₁₄B (RE represents a rare earth element) and grain boundary phase and borides other than the matrix. During working polishing process, cracks and oxidation occur centered on the surface of or the grain boundary vicinity of the sintered magnet. Such oxidation deteriorates the magnetic characteristics of the magnet and appears as a phase having a low coercivity in a demagnetization curve. The crack part is a space and hence is a boundary that is nonmagnetic and uneven, so that reversed magnetic domain tends to occur, thus decreasing the squareness of demagnetization curve. When the fluoride compound solution containing a rare earth element contacts cracks of 1 nm to 1,000 nm wide or the surface of the sintered magnet, a portion of fluorine atoms combines with oxygen or a rare earth element that constitutes the sintered magnet on the boundary and if thermal energy is added thereto, the portion of the fluorine atoms diffuses from the boundary to grow rare earth fluorides or rare earth oxides fluorides and the oxides of rare earth element are reduced to fluorides or oxides fluorides of rare earth elements. At the same time, there occurs an exchange reaction between the rare earth element in the liquid and the rare earth element that constitutes the sintered magnet. Since a liquid is used, this kind of reaction occurs all over the surface that the liquid contacts and growth of mainly the oxide fluoride compound is observed and a rare earth oxide fluoride compound phase grows in the vicinity of the surface of the sintered magnet. In the case of the liquid containing Dy and fluorine, (Dy, Nd)ₓ(F, O, C)_{y} (x and y are positive integers) or the like compound is formed by mutual diffusion between Dy in the liquid and Nd in the sintered magnet. Almost simultaneously with this, atoms of fluorine, rare earth elements, or carbon in the liquid, and so on diffuse along grain boundary into the grains. If the width of the crack is 1,000 nm or less and the thickness of the oxide film is 100 nm or less, it is possible to increase the squareness of the demagnetization curve of the sintered magnet by surface treatment with, for example, an Mg Ca, or Fe fluoride compound liquid that contains no rare earth element. That is, it is possible to recover the magnetic characteristics by reduction of the rare earth oxides. In the case of the sintered magnet in which a heavy rare earth element such as Dy, Tb, or Ho is used in advance, it is possible to grow a heavy rare earth oxide fluoride compound layer by heat treatment by using, for example, such an Mg fluoride compound liquid that contains no rare earth element, diffuse the heavy rare earth element from the oxide fluoride compound along the grain boundary, and segregate the heavy rare earth element in the vicinity of the grain boundary by exchange between the heavy rare earth element and Nd. On this occasion, light weight elements such as fluorine or carbon and nitrogen that diffuse at high rates in the liquid can be detected in the vicinity of the grain boundary. The rare earth elements are known to bind with carbon, boron, nitrogen, or oxygen to form respective compounds. It is possible to realize exchange reaction between a heavy rare earth element and a rare earth element utilizing a difference in free energy of formation of compounds. To increase the magnetic characteristics of the sintered magnet in whole, fluorine and rare earth elements are diffused along the grain boundary and fluorine and rare earth elements are segregated along the grain boundary. Grain boundary diffusion of rare earth elements is aided by light weight elements such as fluorine and carbon that form compounds with rare earth elements. When the rare earth element is diffused front the liquid, the liquid contacts the sintered magnet on its surface, the diffusion proceeds at low temperatures in a range of 200° C. or higher and 500° C. or lower, and the light weight elements diffuse along the grain boundary to help the rare earth elements diffuse. This causes the fluoride compound containing a rare earth element, rare earth oxide fluoride compound, or rare earth carbon oxide fluoride compound, which grows along the grain boundary, to have a decreased grain size. When the fluorine-containing compound that grows on the sintered magnet has a fluorine concentration of 50 atomic % or more, the fluorine-containing compound has high resistance. However, when it has a fluorine concentration of less than 30 atomic %, the resistance decreases abruptly, so that it becomes difficult to make the resistance of the surface of the sintered magnet stabilized to a high resistance by ten times or more. In order to increase the resistance by 50% or more, it is desirable to use a heat treatment temperature of 800° C. or lower, coat the fluorine-containing liquid to a thickness of 100 nm to 1,000 nm, or coat a fluorine-containing liquid having an increased fluorine concentration in order to have a residual fluorine concentration of 30& or more.

The following are descriptions on a stator core fabricated by etching according to the present invention.

A stator core (hereafter, sometimes referred to as “core”) is constituted by a stack of steel sheets. A salient-pole of each steel sheet is formed by etching, preferably photoetching. On this occasion, the steel sheet has a thickness of 0.08 to 0.30 mm.

Of course, it is desirable to perform etching of the stator core in whole from the viewpoint of magnetic characteristics and workability of the production process in whole.

Similarly to the stator core, it is also desirable from the viewpoint of improvement of magnetic characteristics to fabricate a rotor core by etching a silicon steel sheet having a thickness of 0.08 to 0.30 mm. That is, fabrication of stator core or rotor core by punching results in destruction of regular crystal arrangement in the steel sheet, which increases hysteresis loss of the magnet. By fabricating the stator core or rotor core by etching, destruction of regular crystal arrangement can be prevented, so that an increase of hysteresis loss can be prevented.

When a steel sheet to be processed is thinner, punching causes severer problems that cut portions tend to show more turbulence such as buckling, burr, or shear drop to increase hysteresis loss.

Further, shapes that can be formed by punching are simple shapes such as circle and straight line. This is because punching requires a mold and it is difficult to form a mold having a complicated curve. In addition, when a mold is polished, the mold having a complication curved contour is difficult to polish.

Therefore, in machining such as punching, the magnetic steel sheet can be thinned in order to decrease eddy current loss but hysteresis loss increases, so that it is difficult to control the excitation loss to a low level.

Etching can solve such a problem. Etching can decrease hysteresis loss and eddy current loss. In a spindle motor, fabrication of the stator core by etching enables the efficiency of spindle motor in whole to be further increased. Note that a typical example of etching is photoetching.

Etching has the effect of decreasing hysteresis loss by preventing the destruction of regular crystal arrangement in the steel sheet. In addition, it is expectable that the characteristics of the spindle motor are improved by a significant increase in precision of working.

The width of magnetic gap can be adjusted with high precision, so that the characteristics and efficiency of the spindle motor can be improved by decreasing torque pulsation or high-frequency magnetic flux or by decreasing magnetic resistance or leakage of magnetic flux.

Etching enables working the stator core having a contour in a complicated curve that results in improvement of characteristics and an increase in performance, so that etching can readily achieve improvement of characteristics and an increase in performance as compared with punching.

For example, by working the shape of a gap between the stator core and the rotor with high precision, not only the efficiency can be increased but also an increase in performance and improvement of characteristics, such as a decrease in pulsations can be achieved.

To be concrete, explanation is made on the following embodiment.

In the present embodiment, the core has a stacking core density of 90.0% to 99.9%, preferably 93.0% to 99.9%.

It is not always impossible to increase the stacking core density by mechanically compressing the stacked core. However, it is not preferred to do so since the excitation loss increases. What is explained in the present embodiment is a technique that can increase the stacking core density without special step for increasing the stacking core density.

Such an increase in stacking core density of the core can decrease the magnetic flux density in the core, which is effective for decreasing the excitation loss of the spindle motor.

In the above case, the stacking core density (%) of the core is obtained under conditions of a thickness of steel sheet of 0.08 to 0.30 mm, a number of cores of about 20 to about 100 (sheets), and a core height of 5 to 20 mm.

The composition of the steel sheet is constituted by 0.001 to 0.067 wt. % of C, 0.1 to 0.6 wt. % of Mn, 0.03 wt. % or less of P, 0.03 wt. % or less of S, 0.01 wt. % or less of Cr, 0.8 wt. % or less of Al, 0.5 to 7.0 wt. % of Si, 0.01 to 0.20 wt. % of Cu, and balance unavoidable impurities and Fe. The unavoidable impurities include gaseous components such as oxygen and nitrogen.

Preferably, the composition of the steel sheet is constituted by 0.002 to 0.020 wt. % of C, 0.1 to 0.3 wt. % of Mn, 0.02 wt. % or less of P, 0.02 wt. % or less of S, 0.05 wt. % or less of Cr, 0.5 wt. % or less of Al, 0.8 to 6.5 wt. % of Si, 0.01 to 0.1 wt. % of Cu, and balance unavoidable impurities and Fe and contains crystal grains. This is a so-called silicon steel sheet as a magnetic steel sheet.

In determining the composition of such a silicon steel sheet, the contents of Si and Al are important from the view point of decreasing the excitation loss. When Al/Si is defined from this viewpoint, it is preferred that the ratio Al/Si is 0.01 to 0.60, more preferably 0.01 to 0.20.

The concentration of Si in the silicon steel sheet is 0.8 to 2.0 wt. % or 4.5 to 6.5 wt. %. Either one of these silicon steel sheets with different Si contents may be used depending on the type of the spindle motor.

With a decreased content of silicon, the magnetic flux density of the silicon steel sheet increases. In the present embodiment, the magnetic flux density of the silicon steel sheet can be set to 1.8 T to 2.2 T.

When the silicon content is low, the rolling workability increases, so that the thickness of the steel sheet can be decreased. By decreasing the thickness of the steel sheet, also the excitation loss decreases. On the other hand, when the silicon content is high, the decrease in rolling workability can be solved by contriving ways to introduce silicon to the silicon steel sheet after the rolling. This also decreases the excitation loss.

The distribution of silicon contained in the silicon steel sheet may be such that silicon is diffused substantially uniformly in the direction of the thickness of the silicon steel sheet. Alternatively, the concentration of silicon may be partially increased such that the concentration of Si in the surface is higher than the concentration of the inside in the direction of the thickness of the silicon steel sheet.

The core has an insulation coating having a thickness of 0.01 μm to 0.2 μm between any adjacent two stacked steel sheets. There are two types of spindle motors in respect of the thickness of the insulation coating. One spindle motor has insulation coatings having a thickness of 0.1 μm to 0.2 μm, preferably 0.12 μm to 0.18 μm and another has insulation coatings having a thickness of 0.01 μm to 0.05 μm, preferably 0.02 μm to 0.04 μm.

When the thickness of an insulation coating is 0.1 μm to 0.2 μm, it is preferred that the insulation coating is made of an organic film or an inorganic film. The material of the insulation coating that can be used may include an organic material, an inorganic material, and a hybrid material that contains the organic material and the inorganic material in admixture.

When the thickness of an insulation coating is 0.01 μm to 0.05 μm, it is preferred that the insulation coating is an oxide coating. In particular, an iron oxide coating is preferred.

That is, by decreasing the thickness of the silicon steel sheet, the thickness of the insulation coating can be decreased.

The insulation coating of a conventional magnetic steel sheet has a thickness and a composition that are controlled in order to maintain insulation properties after punching and at the same time increase punching ability itself, taking into consideration characteristics other than insulation property, such as lubricity, adherence of steel sheets, heat resistance in annealing after punching, and weldability upon forming the core by welding a stack of steel sheets. Thus, it has been required that the conventional magnetic steel sheet has a thickness of about 0.3 μm.

However, the thinned silicon steel sheet according to the present embodiment must have a decreased thickness of insulation coating.

If the thickness of the insulation coating similar to the conventional insulation coating, the decrease in thickness of the steel sheet means an increase in volume ratio of the insulation coating relative to the volume ratio of the silicon steel sheet, which may result in a decrease in magnetic flux density.

As mentioned above, the silicon steel sheet having a decreased thickness enables the insulation coating to have a decreased thickness accordingly.

Generally, when the magnetic steel sheet is made to have a decreased thickness, the insulation coating must be thick. However, in the present embodiment, when the magnetic steel sheet is made thinner, the insulation coating need not be thicker. On the contrary, the insulation coating can be made thinner along with the magnetic steel sheet. Therefore, the stacking core density of the magnetic steel sheets increases.

The thickness of the magnetic steel sheet must be studied taking into consideration distribution of silicon in the silicon steel sheet and conditions under which the rotor is used. The thickness of may be appropriately used depending on applications between the case where the operation range at the highest rotation speed is on the lower speed side and silicon contained in the steel sheet made of silicon steel sheets diffuses in the direction of the thickness of the steel sheet and the case where the operation at the highest rotation speed is generally several thousands to several ten thousands rpm and the concentration of silicon contained in the steel sheet made of silicon steel sheets is higher at the surface portion than the inside thereof.

The relationship between the rotation speed and the excitation loss is such that the higher the rotation speed is, the more the alternating frequency of the magnetic flux increases, so that the more the excitation loss increases. A spindle motor that operates at a high rotation speed tends to have an increased excitation loss than a spindle motor that operates at a lower rotation speed. It is necessary to study the content of silicon in the silicon steel sheet.

The silicon contained in the silicon steel plate may be uniformly added to the magnetic steel sheet by a dissolution method or locally added, in particular into a surface part, by surface modification, ion implantation, CVD (Chemical Vapor Deposition) or the like method.

The magnetic steel sheet described in the present embodiment has a thickness of 0.08 mm to 0.30 mm supposing that it is used as core having a salient-pole and a yolk that constitutes the stator of a spindle motor. The salient-pole and the yolk can be fabricated by etching.

Etching of magnetic steel sheet having a width of 50 cm to 200 cm is performed by coating a resist on a steel sheet, image-wise exposing the resist to form a pattern of the stator core, developing to remove the resist based on the formed pattern, etching with an etchant to process the steel sheet, and removing the remaining resist.

Thinning of the silicon steel sheets has been considered to be advantageous for decreasing the excitation loss. However, since the workability of rolling silicon steel sheets is low and the workability of punching, which is used in punching the core is low, it has been considered impossible to realize the thinning of the silicon steel sheets on an industrial scale without an increase in cost. Thus, when silicon steel sheet is used as a magnetic steel sheet for use in spindle motor with a high efficiency and low torque pulsation, the thickness of the silicon steel sheet is mainly 0.50 mm and 0.35 mm. There has been no development in thinning of the silicon steel sheet.

However, in the present embodiment, punching is not used and instead, etching is used to make it possible to thinning of the silicon steel sheet for use in the core on an industrial scale without causing a considerable increase in cost and to realize low excitation loss.

In the present embodiment, a silicon steel sheet having a low excitation loss in order to realize a decrease in excitation loss. At the same time, the silicon content is adjusted taking rolling into consideration. The thickness of the sheet is decreased taking into consideration rolling of silicon steel sheet. Etching is applied to form the steel sheet according to the shape of the core. The excitation loss of each of the stacked silicon steel sheets that constitutes the core is decreased. The excitation loss of the core is decreased taking into consideration the insulation coating formed between any two adjacent silicon steel sheets.

In the punching, which is a punching method using a mold, there are formed a work-hardened layer and a plastic deformation layer called burr and shear drop (herein after, referred to as “burr etc.”), generating residual strain or residual stress. The residual stress generated upon punching destructs the regularity of orientation of molecular magnets, that is, destructs magnetic domains to considerably increase the excitation loss. Therefore, an annealing step is necessary to remove the residual stress. The annealing step further increases the production cost of the core.

In the present embodiment, the core is formed by applying such punching as mentioned above, so that the plastic deformation layer is scarcely formed and neither residual strain nor residual stress is generated. Therefore, the orientation of crystal grains is almost never destructed, so that orientation of molecular magnets, that is, orientation of magnetic domains can be prevented and deterioration of hysteresis, one of the magnetic characteristics can be prevented.

The core is formed by stacking the worked silicon steel sheets. By suppressing generation of residual strain or residual stress in the silicon steel sheets, the magnetic characteristics of the core can be further increased.

Therefore, in the spindle motor according to the present embodiment, a decrease in excitation loss, an increase in output, and downsizing can be realized. The magnetic steel sheet used in the spindle motor has substantially no burr etc. in the edge portion and thus are of good quality.

The burr etc. are one of plastic deformation layers, which sharply protrudes along the cut portion in the direction of from the surface of the steel sheet to space. Accordingly, sometimes, the burr etc. break the insulation coating formed on the surface of the magnetic steel sheet to break insulation between the stacked steel sheets.

When stacking such steel sheets, the burr etc. form unnecessary spaces between the stacked steel sheets to prevent the stacking core density from increasing. As a result, the magnetic flux density is decreased. The decrease in magnetic flux density prevents downsizing and weight reduction of the spindle motor.

In some cases a method is performed in which after the magnetic steel sheets are stacked, the resultant core is compressed in the direction of the thickness in order to crash the burr etc, and increase the stacking core density. In this case, the compression increases residual stress to increase excitation loss. In addition, the problem arises that the insulation is broken by the burr etc. remains to be solved.

The core described in the present embodiment generates almost no burr etc., so that the stacking core density can be increased without compression. There occurs no breakage of insulation. Therefore, the excitation loss of the magnet can be decreased.

In the case of the silicon steel sheet as a magnetic steel sheet for use in the core, the content of silicon of 6.5 wt. % provides theoretically the lowest excitation loss. However, according as the content of silicon increases, rolling workability and punching workability are considerably decreased. For this reason, silicon steel sheets having a silicon content of about 3.0 wt. % have been conventionally used in the main taking into consideration rolling workability and punching workability at the sacrifice of excitation loss more or less.

The silicon steel sheet described in the present embodiment can be made to have a decreased thickness of 0.3 mm or less, so that even when the silicon content thereof is 2.0 wt. % or less, the excitation loss is acceptably low.

In the conventional production of silicon steel sheets having a decreased thickness of 0.3 mm or less, special steps such as rolling and annealing are required. In contrast, the silicon steel sheets described in the present embodiment require no such special steps, so that the cost of producing silicon steel sheets having a decreased thickness can be decreased. In the production of the core, no punching is required, so that a further decrease in cost is possible.

Besides the silicon steel sheet, which is a main material for the core, there is known a very expensive amorphous material used as a very thin magnetic material for special applications to a limited extent. The production of an amorphous material involves a special process of rapidly solidifying molten metal to form a foil. With such a process, it is possible to produce the amorphous material in a very small amount, e.g., a thickness of about 0.05 mm and a width of about 300 mm. However, production of the amorphous material having a thickness and a width greater than the above is considered impossible on industrial scale.

As described above, the amorphous material is a material that is hard and brittle and too thin, so that punching can not be applied to it. The chemical components usable are limited so that the amorphous material has a low magnetic flux density. For these and other reasons, it is can not be a main material for the core.

The magnetic steel sheet used in the present embodiment unlike the above-mentioned amorphous material contains crystal grains.

The magnetic steel sheet in the present embodiment can concomitantly realize a decrease in thickness, a decrease in strain, and an increase in output, which are useful for decreasing excitation loss, as well as an increase in dimension precision useful for downsizing and reduction in weight, and an increase in stacking core density useful for increasing magnetic flux density.

That is, according to the present embodiment, a core that realizes a decrease in excitation loss, an increase in output, and downsizing and weight reduction can be provided.

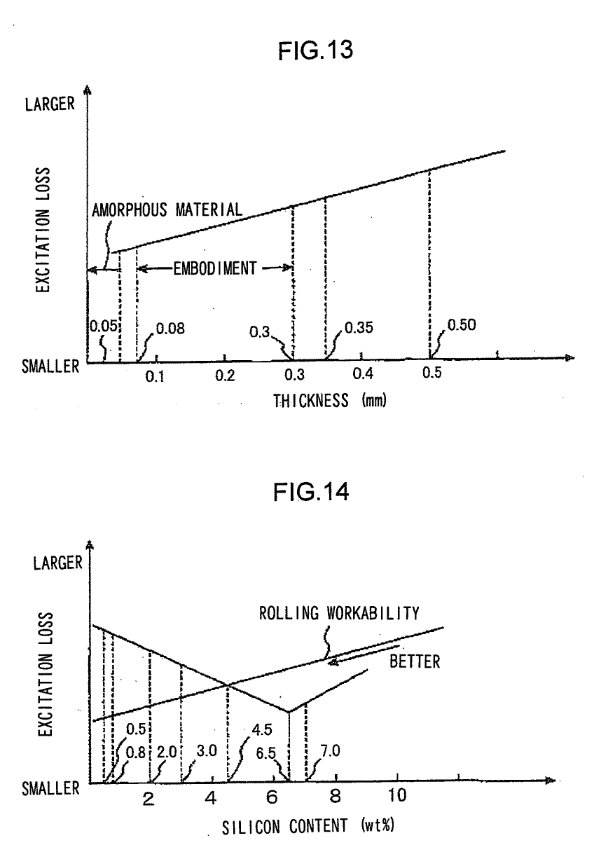

The relationship between the thickness of a magnetic steel sheet and excitation loss is shown in FIG. 13.

FIG. 13 indicates that there is a relationship between thickness of the magnetic steel sheet and the excitation loss such that the thicker the magnetic steel sheet is, the higher the excitation loss is.

The thicknesses of silicon steel sheet that are generally used are 0.50 mm and 0.35 mm, which are selected taking into consideration rolling workability and punching workability.

In the case of two types of silicon steel sheets having the above-mentioned thicknesses used for producing cores, rolling and annealing must be performed thereon in order to decrease excitation loss. To realize a further decrease in thickness, it is necessary to repeat such rolling and annealing in a predetermined number of times which may differ depending on the shape and dimension of the core to be worked. As mentioned above, special steps such as rolling and annealing must be added in the production of the commonly used silicon steel sheet in order to realize a decrease in thickness, which increases production cost.

In contrast, the core in the present embodiment can be mass-produced on industrial scale since the production cost can be decreased and problems upon working of cores can be solved.

In the present embodiment, a silicon steel sheet having a thickness of 0.08 mm to 0.30 mm is used. Preferably, a silicon steel sheet having a thickness of 0.1 mm to 0.2 mm is used and the shape of a core is formed by etching.

FIG. 13 shows a range of thickness of an amorphous material for reference. The amorphous material, which is produced by a special process of rapidly solidifying molten metal to form a foil, is useful for producing a very thin sheet or film having a thickness of about 0.05 mm ore less. It is difficult to produce a sheet of the amorphous material having a thickness greater than 0.05 mm since rapid cooling is difficult. In addition, only a sheet of the amorphous material having a width of about 300 mm can be produced. The special production process used and the limitation in the dimension of the product lead to a very high production cost.

The magnetic characteristics of the amorphous material are such that it has a low excitation loss. However, it has a low magnetic flux density, which is disadvantageous. This is because chemical components that can be used are rather limited due to use of rapid solidification in the production process.

In the present embodiment, silicon steel sheets containing crystal grains are used in contrast to use of such an amorphous material.

The following is a typical production process for a silicon steel sheet.

A material that can be used as a magnetic steel sheet is used to make a steel. For example, a steel sheet material having a composition of 0.05 wt. % of C, 0.2 wt. % of Mn, 0.02 wt. % of P, 0.02 wt. % of S, 0.03 wt. % of Cr, 0.03 wt. % of Al, 2.0 wt. % of Si, 0.01 wt. % of Cu, and balance Fe and impurities is used.

The steel sheet material is subjected to continuous casting, hot rolling, continuous annealing, acid pickling, cold rolling, and continuous annealing to produce a silicon steel sheet having a width of 50 cm to 200 cm, particularly 50 cm, and a thickness of 0.2 mm.

On the surface of the prepared silicon steel sheet, 4.5 wt. % to 6.5 wt. % of silicon may be formed.

Then, an insulation coating of an organic resin having a thickness of 0.1 μm is applied on the surface of the obtained silicon steel sheet to produce an insulated silicon steel sheet.

As the case may be, instead of the stop of special insulation coating, an oxide coating having a thickness of 0.01 μm to 0.05 μm may be made.

The process of forming an insulation coating described herein is preferably performed after the step of etching upon production of a core.

The silicon steel sheet is formed into a flat sheet, or a coil or roll form.

The following explains a production process for a core.

The produced silicon steel sheet is pretreated and a resist is coated thereon. The resist is exposed through a mask having a pattern of a stator core and developed to remove the resist based on the pattern. Further, the obtained silicon steel sheet is etched with an etchant. After this, the remaining resist is removed to produce a silicon steel sheet having a desired shape of the stator core. In this production, for example, photoetching is useful. Also, use of a method for making fine pores with precision using a metal mask is effective.

By stacking a plurality of the produced silicon steel sheets having the desired shape of the stator core and fixing them by welding or the like, a core is produced. Upon welding, it is preferred to use low heat-input welding such as fiber laser welding.

Use of etching in defining the shape of salient-poles enables production of a stator core having a desired shape with a high working precision, for example, with an error of ±10 μm or less, preferably ±5 μm or less.

The error expressed in terms of circularity is 30 μm or less, preferably 15 μm or less, more preferably 10 μm or less. Circularity means degree of deviation of a circular portion from a geometrical regular circle. This is expressed by a difference between radii of two concentric geometrical regular circles holding there between the circular portion such that an area defined between the two concentric geometrical regular circles becomes minimal (i.e., a difference in radii of a circumscribed circle and of an inscribed circle of the circular portion).

FIG. 14 shows relationship between silicon content and excitation loss in a silicon steel sheet.

As shown in FIG. 14, the silicon steel sheet having a silicon content of 6.5 wt. % has the lowest excitation loss. However, when the silicon steel sheet contains a large amount of silicon as much as 6.5 wt. % is difficult to roll, so that it is difficult to produce a silicon steel sheet having a desired thickness. This is because rolling workability of a magnetic steel sheet is lowered with an increasing content of silicon I the magnetic steel sheet. Under the circumstances, silicon steel sheets containing 3.0 wt. % of silicon are used taking into consideration balance between excitation loss and rolling workability.

That is, in the present embodiment, the excitation loss of a silicon steel sheet is lowered by decreasing the thickness of the silicon steel sheet to decrease the influence of silicon content on the excitation loss.

Therefore, the silicon steel sheet in the present embodiment has good rolling workability and provides a wide range of freedom in selecting the silicon content in the silicon steel sheet that has a great influence on the excitation loss by decreasing the thickness of the sheet. From the above-mentioned factors, the content of silicon in the silicon steel sheet can be set to a range of 0.5 wt. % to 7.0 wt. %. This makes it possible to use very different content ranges, i.e., 0.8 wt. % to 2.0 wt. % and 4.5 wt. % to 6.5 wt. %, depending on the specification of the core or applications of the spindle motor.

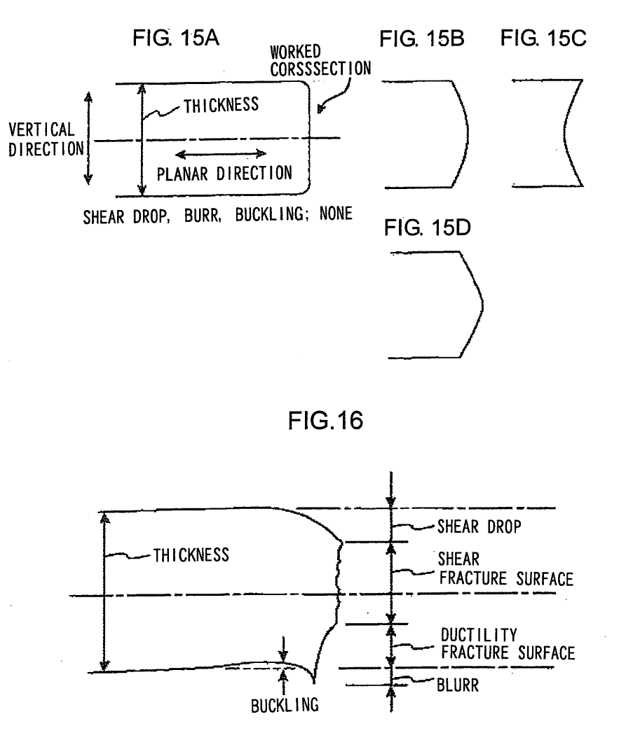

FIGS. 15A to 15D show typical worked cross-sections of a silicon steel sheet by etching.

When a silicon steel sheet is etched, no plastic deformation layer such as burr is present in the vicinity of worked cross-section of the acid-dissolved silicon steel sheet as shown in FIG. 15A. The worked cross-section can be formed substantially vertically with respect to the planar direction of the silicon steel sheet.

By using an advanced etching, the shape of dissolved portion can be controlled as shown in FIGS. 15B to 15D. That is, it is possible to form a predetermined tapered portion or edge and it is also possible to form convex or convex (protrusion or depression) in a direction vertical to the thickness direction. FIG. 15I shows a convex, FIG. 15C shows a concave, and FIG. 15D shows a V-shaped edge.

As mentioned above, the etched silicon steel sheet shows almost no residual stress due to the working (etching) There occurs substantially no plastic deformation layer and the amount of plastic deformation in the direction of thickness of the silicon steel sheet is almost 0 (zero). In addition, the amount of plastic deformation in the vicinity of the worked cross-section formed by etching is almost 0 (zero).

The shape of the worked cross-section of the silicon steel sheet can be controlled. The shape of cut cross-section of which residual stress due to working is almost 0 and of which the amount of plastic deformation in the vicinity of the worked cross-section is almost 0 can be formed.

By using such etching, the silicon steel sheet can be applied to a core in a state where fine crystal texture, mechanical characteristics, surface portion of the silicon steel sheet are optimized. Optimization of the magnetic characteristics of the silicon steel sheet can be realized taking into consideration the anisotropy of the crystal texture of the silicon steel sheet and anisotropy of magnetic characteristics based thereon.

FIG. 16 shows a typical shape of a worked cross-section obtained by punching.

By punching a silicon steel sheet, a portion of the silicon steel sheet in the vicinity of the worked cross-section is considerably deformed due to shearing stress upon plastic working to form burr, shear drop, and buckling having a dimension of 10 μm to 100 μm.

Dimension precision in the planar direction of the silicon steel sheet depends on the dimension precision of a mold in the case of punching. Usually, a silicon steel sheet is sheared at a gap of around 5% of the thickness of the sheet, so that the dimension precision in the planar direction of the silicon steel plate is decreased. Further, when the silicon steel sheet is mass-produced, a problem arises that precision decreases chronologically due to wear of the mold. The thinner the silicon steel sheet is, the more difficult it is to perform the punching.

In the present embodiment to which etching is applied, the problems of precision and chronological decrease in precision are solved.

When the shape of stator core is formed by exposure using a mask with a predetermined pattern, it is preferred to provide a mark or a reference hole concerning the direction of rolling a magnetic steel plate in the pattern.

When magnetic steel plates are stacked one on another, it is necessary for the magnetic steel sheet to have an averaged thickness in the direction of rolling in order to increase the characteristics of the spindle motor. For example, by changing the positions of the marks or reference holes in predetermined amounts in the direction of rolling to align the positions of the marks or reference holes upon stacking the magnetic steel plates, the magnetic characteristics of the resulting spindle motor can be increased.

The spindle motor with thin magnetic steel sheets fabricated by etching has a decreased cogging torque and a decreased excitation loss and also has high precision and high efficiency.

A HDD apparatus with the spindle motor of the present invention has a sufficiently low cogging torque and hence it allows the disk 30 on which magnetic information is recorded to rotate at a speed with minimized variation thereof, so that recording and reproduction of magnetic information can be stable, at high rates, in a large capacity, and with high reliance.

What is claimed is:

1. A spindle motor including a stator and a rotor, the spindle motor comprising:
a stator core provided in the stator having salient-poles;
a stator coil arranged between the salient-poles;
a rotor; and
a permanent magnet provided in the rotor,
wherein the stator core includes a stack of steel sheets whose salient-poles are formed by etching,
wherein all or a portion of the permanent magnet includes a ferromagnetic material consisting mainly of iron,
wherein the ferromagnetic material has formed in laminae on a surface thereof a layer of a fluorine compound containing an alkali element, an alkaline earth element or a rare earth element, and
wherein in the vicinity of a boundary between the ferromagnetic material and the layer of the fluorine compound, iron exists in the layer of the fluorine compound such that a basic crystal structure of the fluorine compound is not changed and the fluorine compound that contains the iron exists in the layer of the fluorine compound.

2. A spindle motor including a stator and a rotor, the spindle motor comprising:
a stator core provided in the stator having salient-poles;
a stator coil arranged between the salient-poles;
a rotor; and
a permanent magnet provided in the rotor,
wherein the stator core includes a stack of steel sheets whose salient-poles are formed by etching,
wherein all or a portion of the permanent magnet includes a ferromagnetic material consisting mainly of iron,
wherein the ferromagnetic material has formed on a surface thereof a layer of a fluorine compound containing an alkali element, an alkaline earth element or a rare earth element, and
wherein in the vicinity of a boundary between the ferromagnetic material and the layer of the fluorine compound, crystal grains containing mixed therein iron in a concentration of 1 atoms or more and 50 atom % or less exist in the layer of the fluorine compound and the crystal grains contain an iron-fluorine compound.

3. A spindle motor including a stator and a rotor, the spindle motor comprising:
a stator core provided in the stator having salient-poles;
a stator coil arranged between the salient-poles;
a rotor; and
a permanent magnet provided in the rotor,
wherein the stator core includes a stack of steel sheets whose salient-poles are formed by etching,
wherein all or a portion of the permanent magnet includes a ferromagnetic material consisting mainly of iron,
wherein the ferromagnetic material has formed on a surface thereof a layer of a fluorine compound containing an alkali element, an alkaline earth element or a rare earth element, and
wherein in the vicinity of a boundary between the ferromagnetic material and the layer of the fluorine compound, crystal grains containing mixed therein iron and oxygen exist in the layer of the fluorine compound and the crystal grains contain an iron oxide fluoride compound.

4. A spindle motor including a stator and a rotor, the spindle motor comprising;
a stator core provided in the stator having salient-poles;
a stator coil arranged between the salient-poles;
a rotor; and
a permanent magnet provided in the rotor,
wherein the stator core includes a stack of steel sheets whose salient-poles are formed by etching,
wherein all or a portion of the permanent magnet includes a ferromagnetic material consisting mainly of iron,
wherein the ferromagnetic material has formed on a surface thereof a layer of a fluorine compound containing an alkali element, an alkaline earth element or a rare earth element,
wherein the fluorine compound is represented by REFₙ where RE represents an alkaline earth element or a fare earth element and n is an integer of 1 to 3, and
wherein in the vicinity of a boundary between the ferromagnetic material and the layer of the fluorine compound, crystal grains containing mixed therein iron or oxygen exist in the layer of the fluorine compound and the crystal grains contain an iron oxide fluoride compound.

5. The spindle motor according to claim 1, wherein in all or a portion of the rotor and the permanent magnet, the fluoride compound, the iron fluoride compound or the iron oxide fluoride compound has an average crystal grain size in a range of 1 nm to 500 nm and the fluorine compound, the iron fluoride compound or the iron oxide fluoride compound has higher resistance than the ferromagnetic material, which is a matrix.

6. The spindle motor according to claim 1, wherein all or a portion of the permanent magnet of the rotor is a high resistance magnet which includes a fluorine compound, an iron fluoride compound or an iron oxide fluoride compound having an average crystal grain size in a range of 1 nm to 500 nm, a recoil permeability of higher than 1.04 and less than 1.30, and a specific resistance of 0.2 mΩcm or more.

7. The spindle motor according to claim 1, wherein
all or a portion of the ferromagnetic material that constitutes the permanent magnet of the rotor includes a compact hot formed with grain growth of the fluorine compound,
the fluorine compound includes a fluoride compound, an iron fluoride compound, or an iron oxide fluoride compound having an increased average crystal grain size in a range of 1 nm to 500 nm as a result of heating and an increased recoil permeability that has increased along with the increase in the average grain size.

8. The spindle motor according to claim 1, wherein
all or a portion of the ferromagnetic material that constitutes the permanent magnet of the rotor includes a sintered compact hot formed with diffusion grain growth of the fluorine compound including a fluoride compound, an iron fluoride compound, or an iron oxy fluoride compound preliminarily formed in matrix particles to undergo diffusion grain growth.

9. The spindle motor according to claim 1, wherein
all or a portion of the ferromagnetic material that constitutes the permanent magnet of the rotor is subjected to hot forming with grain growth of the fluorine compound including a fluoride compound, an iron fluoride compound, or an iron oxy fluoride compound so as to have an increased average crystal grain in a range of 1 nm to 500 nm and an increased recoil permeability that has increased along with the increase in the average grain size.

10. The spindle motor according to claim 1, wherein
all or a portion of the ferromagnetic material containing the rare earth element that constitutes the permanent magnet of the rotor is subjected to hot forming with grain growth of the fluorine compound including a fluoride compound, an iron fluoride compound, or an iron oxy fluoride compound so as to have an increased average crystal grain in a range of 1 nm to 500 nm by heating and an increased recoil permeability that has increased along with the increase in the average grain size.

11. The spindle motor according to claim 1, wherein
the spindle motor is a multi-pole spindle motor, and
the stator has 6 or more salient-pole.

12. The spindle motor according to claim 1, wherein
the spindle motor is a multi-pole spindle motor, and
the rotor has 8 or more poles of the permanent magnet.

13. The spindle motor according to claim 1, wherein
a gap between the stator and the rotor is 0.3 mm or less.
